(19) United States
(12) Patent Application Publication
(10) Pub. No.: US 2024/0314845 A1
(43) Pub. Date: Sep. 19, 2024

(54) NETWORK SLICE SELECTION FOR INACTIVE STATE AND REESTABLISHMENT

(71) Applicant: QUALCOMM Incorporated, San Diego, CA (US)

(72) Inventors: Jianhua LIU, Beijing (CN); Peng CHENG, Beijing (CN)

(21) Appl. No.: 18/262,332

(22) PCT Filed: Mar. 21, 2022
(86) PCT No.: PCT/CN2022/081968

§ 371 Date: Jul. 20, 2023

(30) Foreign Application Priority Data
Apr. 1, 2021 (WO) PCT/CN2021/085000

(51) Int. Cl. H04W 74/0833; H04W 48/18

(52) U.S. Cl. CPC H04W 74/0833; H04W 48/18

(57) ABSTRACT

Aspects of the disclosure relate to user equipment (UE) behavior for intended network slice selection in the radio resource control (RRC) inactive state or for RRC reestablishment. The intended network slice includes one or more single-network slice selection assistance information (S-NSSAIs) utilized by the UE in a particular use case. Examples of use cases include cell reselection in the RRC inactive state, RRC reestablishment, or selection of a random access channel (RACH) resource and/or a RACH parameter to perform an RRC resume procedure in the RRC inactive state. Aspects further relate to UE behavior for selection of a RACH resource to perform a random access procedure when no network slice information is indicated.

### CROSS-REFERENCE TO RELATED APPLICATIONS

The present Application for Patent claims priority to and the benefit of PCT Application No. PCT/CN2021/085000, filed Apr. 1, 2021, and assigned to the assignee hereof and hereby expressly incorporated by reference herein as if fully set forth below in its entirety and for all applicable purposes.

### TECHNICAL FIELD

The technology discussed below relates generally to wireless communication systems, and more particularly, to network slicing enhancements.

### INTRODUCTION

A network slice may be viewed as a logical network with specific functions/elements dedicated for a particular use case, service type, traffic type, or other business arrangements with agreed-upon Service-level Agreement (SLA). Network slice types may include, but not limited to, enhanced Mobile Broadband (eMBB), Ultra-Reliable Low Latency Communications (URLLC), massive Machine Type Communications (mMTC), and massive IoT (mIoT). A network slice may include both access and core network parts of a wireless communication system, such as a New Radio (NR) fifth generation (5G) system (5GS).

The 5GS may handle traffic for different network slices through different protocol data unit (PDU) sessions. Thus, each PDU session may be associated with a respective slice identifier (ID) represented by a single-network slice selection assistance information (S-NSSAI). Network slices are negotiated by a non-access stratum (NAS) registration procedure. For example, a user equipment (UE) may initiate a NAS registration request to an access management function (AMF) in the core network. The registration request may include a requested NSSAI including the S-NSSAI(s) corresponding to the slice(s) to which the UE would like to register. The AMF may respond with a NAS registration accept including a list of allowed S-NSSAIs and rejected S-NSSAIs. The UE may then establish a PDU session associated with an allowed NSSAI. In some examples, a single user equipment (UE) can simultaneously be served by up to eight network slices at any time.

### Brief Summary of Some Examples

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a method for wireless communication at a user equipment is disclosed. The method includes entering a radio resource control (RRC) inactive state and selecting an intended network slice based on at least one of a first list of activated network slices, each associated with a respective activated protocol data unit (PDU) session, or a second list of allowed network slices. The method further includes performing a cell reselection with a radio access network (RAN) based on the intended network slice.

Another example provides a user equipment (UE) in a wireless communication network. The UE includes a transceiver, a memory, and a processor coupled to the transceiver and the memory. The processor and the memory are configured to enter a radio resource control (RRC) inactive state and selecting an intended network slice based on at least one of a first list of activated network slices, each associated with a respective activated protocol data unit (PDU) session, or a second list of allowed network slices. The processor and the memory are further configured to perform a cell reselection with a radio access network (RAN) based on the intended network slice.

Another example provides an apparatus for wireless communication. The apparatus includes means for entering a radio resource control (RRC) inactive state and means for selecting an intended network slice based on at least one of a first list of activated network slices, each associated with a respective activated protocol data unit (PDU) session, or a second list of allowed network slices. The apparatus further includes means for performing a cell reselection with a radio access network (RAN) based on the intended network slice.

Another example provides a non-transitory computer-readable medium having stored therein instructions executable by one or more processors of a user equipment to enter a radio resource control (RRC) inactive state and select an intended network slice based on at least one of a first list of activated network slices, each associated with a respective activated protocol data unit (PDU) session, or a second list of allowed network slices. The non-transitory computer-readable medium further includes instructions executable by the one or more processors of the user equipment to perform a cell reselection with a radio access network (RAN) based on the intended network slice.

Another example provides a method for wireless communication at a user equipment. The method includes entering a radio resource control (RRC) inactive state and selecting an intended network slice based on at least one of a list of activated network slices, each associated with a respective activated protocol data unit (PDU) session, or a slice indication of the intended network slice received from an upper layer. The method further includes selecting at least one of a random access channel (RACH) resource or a RACH parameter based on the intended network slice and performing an RRC resume procedure with a radio access network (RAN) using the RACH resource or the RACH parameter to communicate data with the RAN.

Another example provides a user equipment (UE) in a wireless communication network. The UE includes a transceiver, a memory, and a processor coupled to the transceiver and the memory. The processor and the memory are configured to enter a radio resource control (RRC) inactive state and select an intended network slice based on at least one of a list of activated network slices, each associated with a respective activated protocol data unit (PDU) session, or a slice indication of the intended network slice received from an upper layer. The processor and the memory are further configured to select at least one of a random access channel (RACH) resource or a RACH parameter based on the intended network slice and perform an RRC resume procedure with a radio access network (RAN) using the RACH resource or the RACH parameter to communicate data with the RAN.

Another example provides an apparatus for wireless communication. The apparatus includes means for entering a radio resource control (RRC) inactive state and means for selecting an intended network slice based on at least one of a list of activated network slices, each associated with a respective activated protocol data unit (PDU) session, or a slice indication of the intended network slice received from an upper layer. The apparatus further includes means for selecting at least one of a random access channel (RACH) resource or a RACH parameter based on the intended network slice and means for performing an RRC resume procedure with a radio access network (RAN) using the RACH resource or the RACH parameter to communicate data with the RAN.

Another example provides a non-transitory computer-readable medium having stored therein instructions executable by one or more processors of a user equipment to enter a radio resource control (RRC) inactive state and select an intended network slice based on at least one of a list of activated network slices, each associated with a respective activated protocol data unit (PDU) session, or a slice indication of the intended network slice received from an upper layer. The non-transitory computer-readable medium further includes instructions executable by the one or more processors of the UE to select at least one of a random access channel (RACH) resource or a RACH parameter based on the intended network slice and perform an RRC resume procedure with a radio access network (RAN) using the RACH resource or the RACH parameter to communicate data with the RAN.

Another example provides a method for wireless communication at a user equipment. The method includes entering a radio resource control (RRC) inactive state, triggering a radio access network notification area (RNA) update, and selecting at least one of a random access channel (RACH) resource or a RACH parameter based on at least one of a first list of activated network slices, each associated with a respective activated protocol data unit (PDU) session, a second list of allowed network slices, or a default RACH resource. The method further includes performing an RRC resume procedure with a radio access network (RAN) using the RACH resource or the RACH parameter to perform the RNA update.

Another example provides a user equipment (UE) in a wireless communication network. The UE includes a transceiver, a memory, and a processor coupled to the transceiver and the memory. The processor and the memory are configured to enter a radio resource control (RRC) inactive state, trigger a radio access network notification area (RNA) update, and select at least one of a random access channel (RACH) resource or a RACH parameter based on at least one of a first list of activated network slices, each associated with a respective activated protocol data unit (PDU) session, a second list of allowed network slices, or a default RACH resource. The processor and the memory are further configured to perform an RRC resume procedure with a radio access network (RAN) using the RACH resource or the RACH parameter to perform the RNA update.

Another example provides an apparatus for wireless communication. The apparatus includes means for entering a radio resource control (RRC) inactive state, means for triggering a radio access network notification area (RNA) update, and means for selecting at least one of a random access channel (RACH) resource or a RACH parameter based on at least one of a first list of activated network slices, each associated with a respective activated protocol data unit (PDU) session, a second list of allowed network slices, or a default RACH resource. The apparatus further includes means for performing an RRC resume procedure with a radio access network (RAN) using the RACH resource or the RACH parameter to perform the RNA update.

Another example provides a non-transitory computer-readable medium having stored therein instructions executable by one or more processors of a user equipment to enter a radio resource control (RRC) inactive state, trigger a radio access network notification area (RNA) update, and select at least one of a random access channel (RACH) resource or a RACH parameter based on at least one of a first list of activated network slices, each associated with a respective activated protocol data unit (PDU) session, a second list of allowed network slices, or a default RACH resource. The non-transitory computer-readable medium further includes instructions executable by the one or more processors of the user equipment to perform an RRC resume procedure with a radio access network (RAN) using the RACH resource or the RACH parameter to perform the RNA update.

Another example provides a method for wireless communication at a user equipment. The method includes selecting an intended network slice based on a list of activated network slices, each associated with a respective activated protocol data unit (PDU) session, selecting at least one of a random access channel (RACH) resource or a RACH parameter based on the intended network slice, and performing a radio resource control (RRC) reestablishment procedure with a radio access network (RAN) using the RACH resource or the RACH parameter.

Another example provides a user equipment (UE) in a wireless communication network. The UE includes a transceiver, a memory, and a processor coupled to the transceiver and the memory. The processor and the memory are configured to select an intended network slice based on a list of activated network slices, each associated with a respective activated protocol data unit (PDU) session, select at least one of a random access channel (RACH) resource or a RACH parameter based on the intended network slice, and perform a radio resource control (RRC) reestablishment procedure with a radio access network (RAN) using the RACH resource or the RACH parameter.

Another example provides an apparatus for wireless communication. The apparatus includes means for selecting an intended network slice based on a list of activated network slices, each associated with a respective activated protocol data unit (PDU) session, means for selecting at least one of a random access channel (RACH) resource or a RACH parameter based on the intended network slice, and means for performing a radio resource control (RRC) reestablishment procedure with a radio access network (RAN) using the RACH resource or the RACH parameter.

Another example provides a non-transitory computer-readable medium having stored therein instructions executable by one or more processors of a user equipment to select an intended network slice based on a list of activated network slices, each associated with a respective activated protocol data unit (PDU) session, select at least one of a random access channel (RACH) resource or a RACH parameter based on the intended network slice, and perform a radio resource control (RRC) reestablishment procedure with a radio access network (RAN) using the RACH resource or the RACH parameter.

Another example provides a method for wireless communication at a user equipment. The method includes selecting a random access channel (RACH) resource of a plurality of RACH resources based on one of a default RACH resource, a respective slice priority of each of a plurality of network slices, wherein each of the plurality of network slices is associated with a respective one of the plurality of RACH resources, or a respective set of allowed network slices of the plurality of network slices. The method further includes performing a random access procedure with a radio access network (RAN) using the selected RACH resource.

Another example provides a user equipment (UE) in a wireless communication network. The UE includes a transceiver, a memory, and a processor coupled to the transceiver and the memory. The processor and the memory are configured to select a random access channel (RACH) resource of a plurality of RACH resources based on one of a default RACH resource, a respective slice priority of each of a plurality of network slices, wherein each of the plurality of network slices is associated with a respective one of the plurality of RACH resources, or a respective set of allowed network slices of the plurality of network slices. The processor and the memory are further configured to perform a random access procedure with a radio access network (RAN) using the selected RACH resource.

Another example provides an apparatus for wireless communication. The apparatus includes means for selecting a random access channel (RACH) resource of a plurality of RACH resources based on one of a default RACH resource, a respective slice priority of each of a plurality of network slices, wherein each of the plurality of network slices is associated with a respective one of the plurality of RACH resources, or a respective set of allowed network slices of the plurality of network slices. The apparatus further includes means for performing a random access procedure with a radio access network (RAN) using the selected RACH resource.

Another example provides a non-transitory computer-readable medium having stored therein instructions executable by one or more processors of a user equipment to select a random access channel (RACH) resource of a plurality of RACH resources based on one of a default RACH resource, a respective slice priority of each of a plurality of network slices, wherein each of the plurality of network slices is associated with a respective one of the plurality of RACH resources, or a respective set of allowed network slices of the plurality of network slices. The non-transitory computer-readable medium further includes instructions executable by the one or more processors of the user equipment to perform a random access procedure with a radio access network (RAN) using the selected RACH resource.

These and other aspects of the invention will become more fully understood upon a review of the detailed description, which follows. Other aspects, features, and examples will become apparent to those of ordinary skill in the art, upon reviewing the following description of specific, exemplary examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples it should be understood that such exemplary examples can be implemented in various devices, systems, and methods.

### BRIEF DESCRIPTION OF THE DRAWINGS

FIG. 1 is a schematic illustration of a wireless communication system according to some aspects.

FIG. 2 is a diagram illustrating an example of a frame structure for use in a radio access network according to some aspects.

FIG. 3 is a conceptual illustration of an example of a radio access network according to some aspects.

FIG. 4 is a block diagram illustrating an example of a 5G wireless communication system (5GS) according to some aspects.

FIG. 5 is a diagram illustrating an example of a random access procedure according to some aspects.

FIG. 6 illustrates an example of 5G state transitions according to some aspects.

FIG. 7 is a block diagram conceptually illustrating an example of a hardware implementation for a user equipment according to some aspects.

FIG. 8 is a flow chart of an exemplary method of wireless communication at a user equipment according to some aspects.

FIG. 9 is a flow chart of another exemplary method of wireless communication at a user equipment according to some aspects.

FIG. 10 is a flow chart of another exemplary method of wireless communication at a user equipment according to some aspects.

FIG. 11 is a flow chart of another exemplary method of wireless communication at a user equipment according to some aspects.

FIG. 12 is a flow chart of another exemplary method of wireless communication at a user equipment according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure relate to procedures for a UE to select an intended network slice in various use cases, such as in the radio resource control (RRC) inactive state or during an RRC reestablishment procedure in the RRC connected state. The intended network slice generally refers to the S-NSSAI(s) utilized by the UE in a particular use case, such as cell reselection in the RRC inactive state, selection of a RACH resource and/or a RACH parameter to perform an RRC resume procedure in the RRC inactive state, or cell reselection and/or selection of a RACH resource and/or RACH parameter for RRC reestablishment. The intended network slice may be different in different use cases and may be based on information that an access stratum (AS) layer in the UE receives from a non-access stratum (NAS) layer in the UE for the particular use case. In addition, aspects further relate to a procedure for a UE to select a random access channel (RACH) resource to perform a random access procedure when no network slice information is available or when performing an RRC resume procedure to update a radio access network notification area (RNA).

In some examples, to perform cell reselection in the RRC inactive state, the UE may select the intended network slice from either a first list of activated network slices, each associated with an activated protocol data unit (PDU) session, or a second list of allowed network slices configured to the UE. Here, an activated PDU session refers to a PDU session for which a UE context has been established and one or more data radio bearers (DRBs) have been configured. In this example, the UE may further select the intended network slice based on a respective slice priority of each of the activated network slices (e.g., when the first list is utilized to select the intended network slice) or each of the allowed network slices (e.g., when the second list is utilized to select the intended network slice). For example, the UE may select the intended network slice as the network slice having the highest priority.

In some examples, to perform an RRC resume procedure from an RRC inactive state to communicate data with a radio access network (RAN), the UE may select the intended network slice for selecting a RACH resource and/or a RACH parameter from either a list of activated network slices, each associated with an activated protocol data unit (PDU) session, or based on a slice indication of the intended network slice received from an upper layer (e.g., the NAS layer). In this example, the UE may further select the intended network slice based on a respective slice priority of each of the activated network slices.

In some examples, to perform an RRC resume procedure from an RRC inactive state to update a radio access network notification area (RNA), the UE may select a RACH resource and/or a RACH parameter based on either a first list of activated network slices, each associated with an activated protocol data unit (PDU) session, a second list of allowed network slices configured to the UE, or a default RACH resource. In this example, the UE may further select an intended network slice and select the RACH resource and/or RACH parameter based on the intended network list. For example, the UE may select the intended network slice based on a respective slice priority of each of the activated network slices (e.g., when the first list is utilized to select the intended network slice) or each of the allowed network slices (e.g., when the second list is utilized to select the intended network slice).

In some examples, to perform an RRC reestablishment procedure with a RAN, the UE may select the intended network slice for selecting a RACH resource and/or a RACH parameter from a list of activated network slices, each associated with an activated PDU session. For example, the UE may select the intended network slice based on a respective slice priority of each of the activated network slices. As another example, the UE may select the intended network slice associated with one of the activated PDU sessions having uplink data to be transmitted to the RAN.

In some examples, to perform a random access procedure with a RAN, the UE may select a RACH resource based on a default RACH resource, a respective slice priority of each of a plurality of network slices, where each network slice is associated with a RACH resource, or a respective set of allowed network slices. For example, the UE may select the RACH resource associated with the lowest priority network slice. As another example, the UE may select the RACH resource associated with a highest priority allowed slice.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

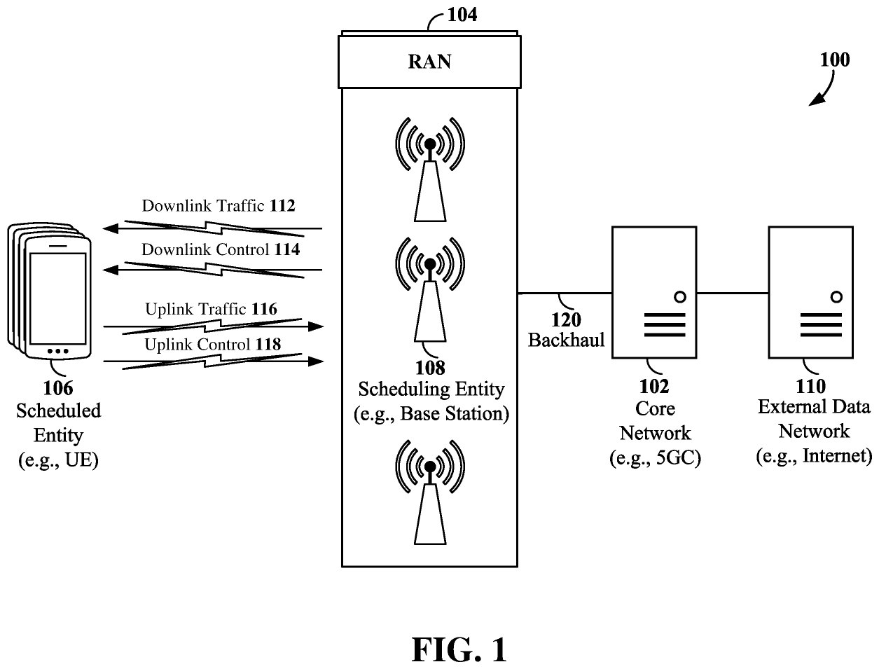

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110. such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (CUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (CNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station. In addition, one or more of the base stations may have a disaggregated configuration.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmissions. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

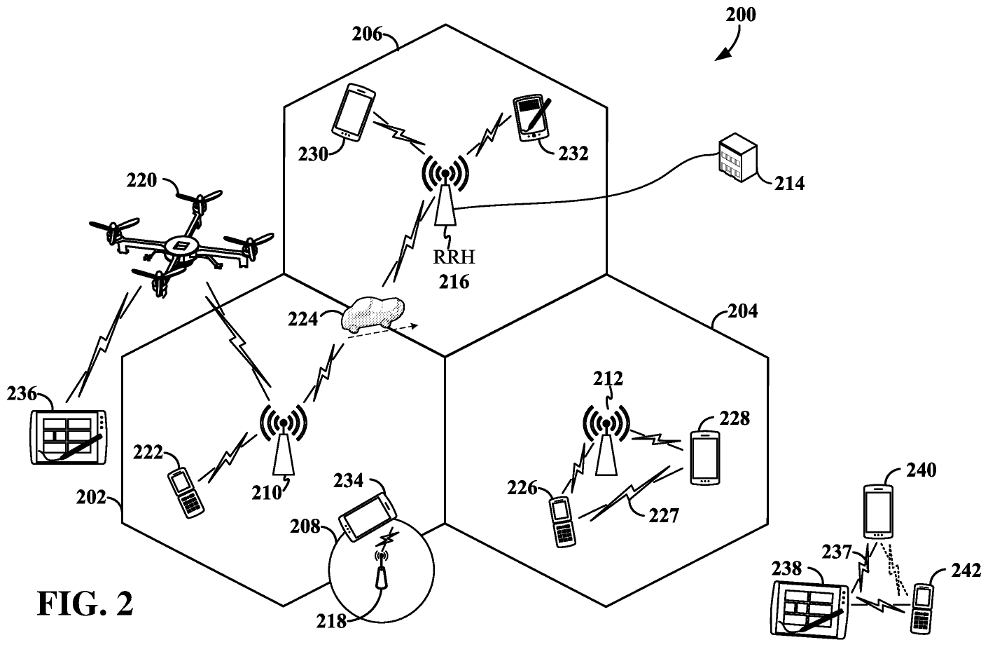

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

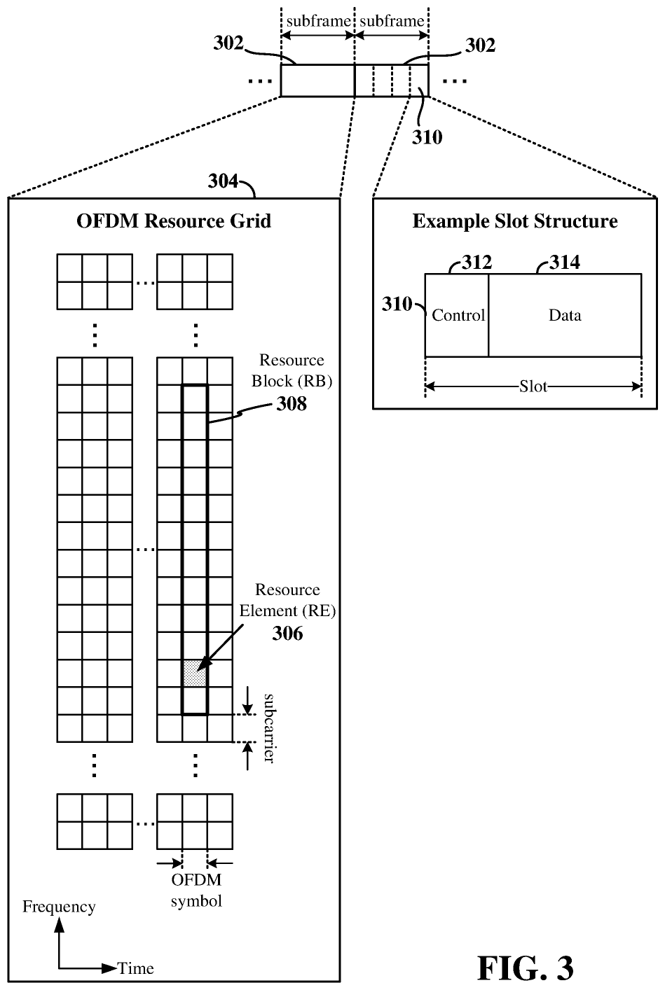

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, cNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

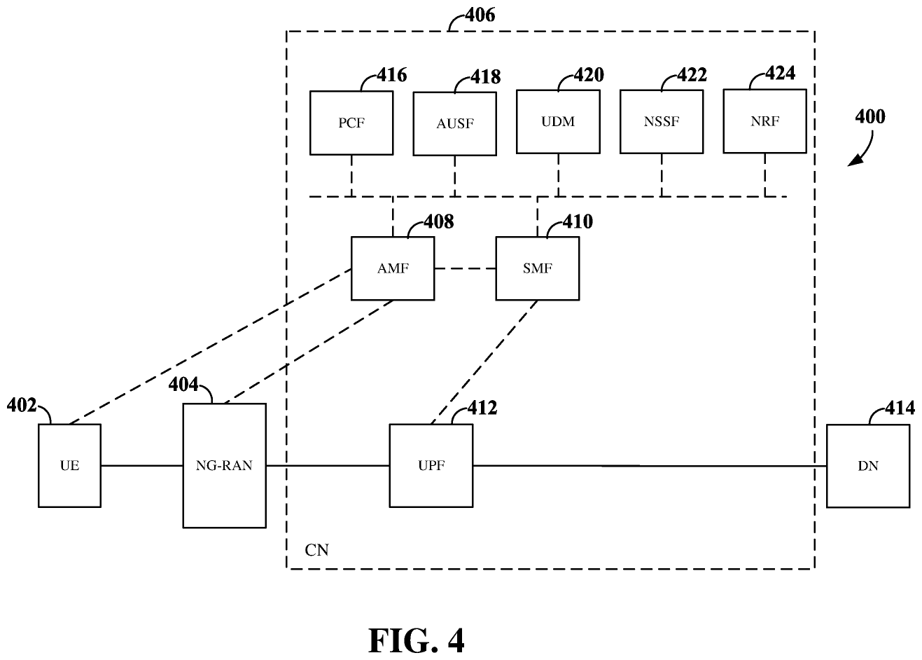

Referring now to FIG. 4, by way of example and without limitation, a block diagram illustrating an example of various components of a 5G wireless communication system (5GS) 400 is provided. In some examples, the 5GS 400 may correspond to the wireless communication system 100 described above and illustrated in FIG. 1. The 5GS 400 includes a user equipment (UE) 402, a NG-RAN 404, and a core network 406 (e.g., a 5G CN). The NG-RAN 404 may be a 5G RAN and correspond, for example, to the RAN 200 described above and illustrated in FIG. 2. In addition, the UE 402 may correspond to any of the UEs or other scheduled entities shown in FIG. 1 or 2. By virtue of the wireless communication system 400, the UE 402 may be enabled to carry out data communication with an external data network 414, such as (but not limited to) the Internet or an Ethernet network.

The core network 406 may include, for example, an access and mobility management function (AMF) 408, a session management function (SMF) 410, and a user plane function (UPF) 412. The AMF 408 and SMF 410 employ control plane (e.g., non-access stratum (NAS)) signaling to perform various functions related to mobility management and session management for the UE 402. For example, the AMF 408 provides connectivity, mobility management and authentication of the UE 402, while the SMF 410 provides session management of the UE 402 (e.g., processes signaling related to protocol data unit (PDU) sessions between the UE 402 and the external DN 414). The UPF 412 provides user plane connectivity to route 5G (NR) packets to/from the UE 402 via the NG-RAN 404.

As used herein, the term non-access stratum (NAS) may, for example, generally refer to protocols between the UE 402 and the core network 406 that are not terminated in the NG-RAN 404. In addition, the term access stratum may, for example, generally refer to a functional grouping consisting of the parts in the NG-RAN 404 and in the UE 402, and the protocols between these parts being specific to the access technique (i.e., the way the specific physical media between the UE 402 and the NG-RAN 404 is used to carry information).

The core network 406 may further include other functions, such as a policy control function (PCF) 416, authentication server function (AUSF) 418, unified data management (UDM) 420, network slice selection function (NSSF) 422, a network repository function (NRF) 424, and other functions (not illustrated, for simplicity). The PCF 416 provides policy information (e.g., rules) for control plane functions, such as network slicing, roaming, and mobility management. In addition, the PCF 416 supports 5G quality of service (QOS) policies, network slice policies, and other types of policies. The AUSF 418 performs authentication of UEs 402. The UDM 420 facilitates generation of authentication and key agreement (AKA) credentials, performs user identification and manages subscription information and UE context. The NSSF 422 redirects traffic to a network slice. Network slices may be defined, for example, for different classes of subscribers or use cases, such as smart home, Internet of Things (IoT), connected car, smart energy grid, etc. Each use case may receive a unique set of optimized resources and network topology (e.g., a network slice) to meet the connectivity, speed, power, and capacity requirements of the use case. The NRF 424 is a central repository for all of the 5G network functions (NFs) in the wireless communication system 400. The NRF 424 enables NFs to register and discover one another. In addition, the NRF 424 supports a 5G service-based architecture (SBA).

To establish a connection to the core network 406 (e.g., a 5G core network) via the NG-RAN 404, the UE 402 may transmit a registration request to the AMF 408 core network 406 via the NG-RAN 404. The AMF 408 may then initiate non access stratum (NAS) level authentication between the UE 402 and the core network 406 (e.g., via the AUSF 418 and UDM 420). The AMF 408 may then retrieve mobility subscription data, SMF selection data, and UE context and communicate with the PCF 416 for policy association for the UE 402. The AMF 408 may then send a NAS secure registration accept message to the UE 402 to complete the registration.

Once the UE 402 has registered with the core network 406, the UE 402 may transmit a PDU session establishment request to establish one or more PDU sessions to the core network 406 via the NG-RAN 404. The AMF 408 and SMF 410 may process the PDU session establishment request and establish a data network session (DNS) between the UE 402 and the external DN 414 via the UPF 412. A DNS may include one or more sessions (e.g., data sessions or data flows) and may be served by multiple UPFs 412 (only one of which is shown for convenience). Examples of data flows include, but are not limited to, IP flows, Ethernet flows and unstructured data flows.

In some examples, each PDU session may be associated with a respective network slice. The 5GS 400 may allow for multiple instances of a network slice (also referred to as network slice instances). For example, a network slice instance may include a set of network function instances and resources (e.g., compute, storage, and networking resources) which form a network slice. Each network slice instance may provide the network characteristics associated with a service supported by the 5GS 400.

In the 5GS 400, network slice selection assistance information (NSSAI) may refer to a collection of identifiers for network slices, where each identifier is referred to as single-network slice selection assistance information (S-NSSAI). In some examples, an S-NSSAI identity may include a slice/service type (SST) and a slice differentiator (SD). The SST may indicate the expected network slice behavior in terms of features and services, and the SD may be optionally used to differentiate among multiple network slices of the same SST. An S-NSSAI may have standard values or non-standard values. For example, an S-NSSAI with a standard value may mean that the S-NSSAI includes an SST with a standardized SST value. In one example, an SST value 1 may be associated with an eMBB network slice type, which may be suitable for handling 5G enhanced mobile broadband. In another example, an SST value 2 may be associated with a URLLC network slice type, which may be suitable for handling ultra-reliable low latency communications. In yet another example, an SST value 3 may be associated with an MIOT network slice type, which may be suitable for handling of massive IoT.

The UE 402 may request one or more S-NSSAIs when the UE 402 registers with the core network 406. For example, the UE 402 can transmit a radio resource control (RRC) message (Msg5) including an access stratum (AS)-requested NSSAI and a NAS registration request including the requested NSSAI. Here, an NSSAI includes a set of one or more S-NSSAI(s) Thus, the requested NSSAI may include, for example, the S-NSSAI(s) corresponding to the slice(s) to which the UE 402 is requesting to register. In some examples, the requested S-NSSAI(s) included in Msg5 may be a subset of the requested S-NSSAI(s) included in the NAS registration request message since Msg5 does not include security protection. The NG-RAN 404 can route the NAS registration request to the AMF 408, which may be selected using the requested NSSAI obtained from the AS message in Msg5. If the NG-RAN 404 is unable to select an AMF based on the requested NSSAI, the NG-RAN 404 may route the NAS registration request to an AMF from a set of default AMFs.

The AMF 408 may then respond with a NAS registration accept message including a list of allowed S-NSSAIs (allowed-NSSAI) and a list of rejected S-NSSAIs (rejected-NSSAI). The allowed NSSAI may include a minimum common set of the requested NSSAI (or default S-NSSAI(s) if no valid S-NSSAI is requested), the subscribed NSSAI, and the NSSAI supported by the current tracking area (TA) of the UE 402. In general, once a network slice is created, the slice is valid within a registration area (RA), which includes one or more tracking areas (TAs).

The AMF 408 verifies whether the S-NSSAI(s) in the requested NSSAI are permitted based on the subscribed S-NSSAIs in the UE context. In some examples, the AMF 408 may query the NSSF 422, with the requested NSSAI, the subscribed S-NSSAIs, the public land mobile network (PLMN) identifier (ID) of the NG-RAN 404, and other suitable information to retrieve the network slice instances (NSIs) to serve the UE 402. The AMF 408 may then include the permitted S-NSSAIs in the allowed-NSSAI and the not permitted S-NSSAIs in the rejected-NSSAI in the NAS registration accept message to the NG-RAN 404. The NG-RAN 404 may then forward the NAS registration accept message to the UE 402 within an RRC reconfiguration message to establish an RRC connection and a signaling radio bearer (SRB). A SRB is a logical communication channel on L2 and higher layers for the transfer of control information between the UE 402 and the NG-RAN 404. For example, the SRB may carry a dedicated control channel (DCCH) including physical (PHY) layer, medium access control (MAC) layer, and other access layer control information.

The UE 402 may then establish a PDU session associated with an S-NSSAI within the allowed-NSSAI. For example, the UE 402 may transmit a PDU session establishment request over NAS signaling to the core network 406 (e.g., the AMF 408). The PDU session establishment request may include the S-NSSAI and a data network name (DNN) of a DN 414 to which the PDU session is intended. SMF 410 discovery and selection within the selected NSI indicated by the S-NSSAI may then be initiated by the AMF 408.

In some examples, the NRF 424 may assist the discovery and selection tasks of the required network functions for the selected NSI. For example, the AMF 408 may query the NRF 424 to select an SMF 410 in a NSI based on S-NSSAI, DNN and other information, e.g., UE subscription and local operator policies. The selected SMF 410 may then establish the PDU Session, which may include one or more quality of service (QOS) flows, with the DN 414 based on S-NSSAI and DNN. At the NAS level, a QoS flow is characterized by a QoS profile provided by the 5GC 406 to NG-RAN 404 and QoS rule(s) provided by 5GC 406 to the UE 402. The QoS profile is used by NG-RAN 404 to determine the treatment on the radio interface while the QoS rules dictate the mapping between uplink user plane traffic and QoS flows to the UE 402.

Upon establishing the PDU session, the NG-RAN 404 establishes one or more Data Radio Bearers (DRB) for the PDU Session. A DRB is a logical communication on L2 and higher layers for the transfer of data for the PDU session. For example, a DRB carries dedicated traffic channel (DTCH) data for a PDU session. A DRB may be established using a radio bearer (RB) setup procedure on the SRB. The NG-RAN 404 can map packets belonging to different PDU sessions to different DRBs. NAS level packet filters in the UE 402 and in the 5GC 406 can further associate uplink and downlink packets with QoS, and AS level mapping rules in the UE 402 and in the NG-RAN 404 can associate uplink and downlink QoS Flows with DRBs.

To obtain a resource for transmitting Msg5 including the AS-requested NSSAI and NAS registration request including the NAS-requested NSSAI, a UE 402 may perform a random access procedure. over a physical random access channel (PRACH) to perform an RRC setup procedure to establish an RRC connection with the NG-RAN 404. After completing the RRC setup procedure, the UE 402 may transmit an RRC setup complete message (Msg5) to the NG-RAN including the registration request. The random access procedure described herein may be referred to as a 4-step random access procedure. However, aspects of the present disclosure may also apply to a 2-step random access procedure.

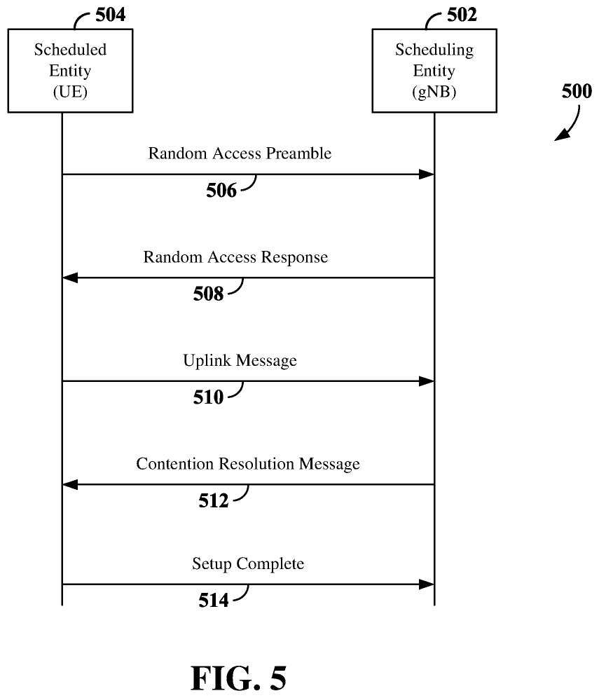

FIG. 5 is a diagram illustrating an example of a 4-step contention-based random access (CBRA) procedure 500 between a base station 502 and a UE 504. The base station 502 may correspond, for example, to any of the base stations (gNBs, eNBs, etc.) or other scheduling entities shown in FIGS. 1, 2, and/or 4. In addition, the UE 504 may correspond, for example, to any of the UEs or other scheduled entities shown in FIGS. 1,2 and/or 4.

The random access procedure 500 shown in FIG. 5 is initiated by the UE 504 randomly selecting a preamble from an available set of preambles within the cell served by the base station 502, and transmitting the selected preamble to the base station 502 in a RACH preamble message 506 (Msg1). In an example, the UE 504 may select from 64 possible preamble sequences for inclusion in the RACH preamble message 506. The Msg1 506 may be transmitted by the UE 504 over a selected RACH resource with power ramping. The selected RACH resource may include supplementary uplink resources or normal uplink resources. Here, supplementary uplink resources include lower frequency resources than normal uplink resources. Thus, supplementary uplink resources and uplink resources each correspond to a different respective uplink frequency band. The Msg1 506 may further be communicated on a beam selected by the UE 504 based on beam measurements (e.g., RSRP/RSRQ/SINR) performed by the UE 504. The beam may correspond, for example, to an SSB beam.

If the preamble is successfully detected by the base station 502, the base station 502 transmits a random access response (RAR) message 508 (Msg2) including a PDCCH and PDSCH to the UE 504. If no Msg2 (RAR) 508 is received within a RAR window, the UE 504 may retransmit Msg1 506 with power boost. The Msg2 508 (PDCCH+PDSCH) includes an identifier of the preamble sent by the UE 504, a Timing Advance (TA), a temporary cell radio network temporary identifier (TC-RNTI) or random access (RA) RNTI for the UE 504 and a grant of assigned uplink (UL) resources. The PDCCH in Msg2 508 may be scrambled with the RA-RNTI, which is a function of a RACH occasion (RO) (e.g., time-frequency resources allocated for RACH Msg1) that the UE 504 used to send Msg1 506. A medium access control-control element (MAC-CE) within the PDSCH provides an acknowledgement of the reception of Msg1 and the UL grant. To receive Msg2 508, the UE 504 may monitor DCI 1_0 for the PDCCH scrambled with the RA-RNTI corresponding to the RO used by the UE 504 to transmit Msg1 506, and if detected, proceeds with PDSCH decoding. Upon receipt of the RAR message 508, the UE 504 compares the preamble ID to the preamble sent by the scheduled entity in the RACH preamble message 506. If the preamble ID matches the preamble sent in the RACH preamble message 506, the UE 504 applies the timing advance and starts a contention resolution procedure.

Since the preamble is selected randomly by the scheduled entity, if another scheduled entity selects the same preamble in the same RO, a collision may result between the two scheduled entities. Any collisions may then be resolved using the contention resolution procedure. During contention resolution, the UE 504 transmits an uplink message (Msg3) 510 on the common control channel (CCCH) using the TA and assigned uplink resources in the PDSCH of Msg2 508. In an example, the uplink message 510 is a Layer 2/Layer 3 (L2/L3) message, such as a Radio Resource Control (RRC) Setup Request message. The uplink message 510 includes an identifier of the UE 504 (UE-ID) for use by the scheduling entity in resolving any collisions. Although other scheduled entities may transmit colliding uplink messages utilizing the TA and assigned uplink resources, these colliding uplink messages will likely not be successfully decoded at the scheduling entity since the colliding uplink messages were transmitted with TAs that were not intended for those scheduled entities.

Upon successfully decoding the uplink message, the base station 502 transmits a contention resolution message 512 to the UE 504 (Msg4). The contention resolution message 512 may be, for example, an RRC-Connection Setup message. In addition, the contention resolution message 512 includes the identifier of the UE 504 that was received in the uplink message 510. The UE 504, upon receiving its own identity back in the contention resolution message 512, concludes that the random access procedure was successful and completes the RRC connection setup process. Any other scheduled entity receiving the RRC-Connection Setup message with the identity of the UE 504 will conclude that the random access procedure failed and re-initialize the random access procedure.

To complete the RRC connection setup process, the contention resolution message 512 (Msg4) may further include a PDCCH (DCI Format 0_0) including a grant of assigned uplink (UL) resources for the UE 504 to transmit an RRC setup complete message 514 (Msg5) to the base station 502. The RRC setup complete message may further include a dedicated NAS message containing the registration request. The NAS registration request may include, for example, the requested NSSAI, UE capability, list of PDU sessions, and other suitable information. The RRC setup complete message 514 may further include the AS-requested NSSAI. Based on the AS-requested NSSAI, the base station 502 may select the AMF for completing the registration request, as described above in connection with FIG. 4.

The random access procedure shown in FIG. 5 may be utilized for initial access from an RRC idle state. In addition, a UE 504 may perform a random access procedure, similar to the random access procedure shown in FIG. 5, for RRC reestablishment, handover, when downlink data arrives at the base station 502 while the UE 504 is in an RRC inactive state or an RRC connected state and not synchronized with the base station 502, when uplink data arrives in an uplink buffer of the UE 504 while the UE 504 is in an RRC inactive state or an RRC connected state and either not synchronized or there are no PUCCH resources available to transmit a scheduling request, or for positioning purposes while the UE 504 is in an RRC connected state and a timing advance is needed for positioning. Random access may further be used for other purposes, such as performing a radio access network notification area (RNA) update when the UE has moved out of the configured RNA for the UE, performing a tracking area (TA)/RAN area (RA) update, or requesting system information (SI). The RNA can include, for example, one or more cells, one or more RAs or one or more TAs.

For example, for RRC reestablishment, an RRC reestablishment message may be sent in Msg3 of the random access procedure shown in FIG. 5. As another example, to resume data transmission (e.g., due to the presence of downlink data at the base station 502 or uplink data at the UE 504) or perform an RNA update or for other purposes, the UE 504 may transmit an RRC resume message in Msg3 of the random access procedure shown in FIG. 5.

In some examples, slice-specific RACH resources may be defined in addition to existing common RACH resources from which the UE may select for transmitting Msg1. For example, the slice-specific RACH resources may be configured in a slice-specific RACH resource pool separate from the common RACH resource pool, and may further be configured per slice or per slice group. In addition, slice-specific RACH parameters may also be configured per slice or per slice group. Examples of slice-specific RACH parameters may include, but are not limited to, powerRampingStepHighPriority, which indicates the power-ramping factor in case of prioritized random access procedure, and scalingFactorBI, which is a scaling factor for prioritized random access.

In some examples, the slice priority may be configured via RRC, SIB, or NAS. In examples in which the slice priority is configured via RRC or SIB, some network slice(s) may be configured with isolated RACH resources or prioritized RACH parameters (e.g., the slice-specific RACH parameters mentioned above) that are different from the common cell-specific RACH resources. In examples in which arriving downlink traffic triggers RACH, NAS signaling may indicate the slice identifier (ID), such as the S-NSSAI(s), to the access stratum (AS) in the UE. The AS in the UE may then select the corresponding RACH resource and/or RACH parameters for RACH access.

The selected network slice for a RACH resource and/or RACH parameter may be considered an intended network slice. As used herein, an intended network slice refers to a set of one or more S-NSSAI(s) to be utilized by the UE for one or more use cases. Thus, an intended network slice may correspond to an NSSAI. Examples of use cases may include the selection of a RACH resource and/or RACH parameter for various purposes (e.g., RRC reestablishment, RRC resume, etc.), cell selection, cell reselection, and other types of use cases. The intended network slice may be different in different use cases and may be based on the information the AS receives from the NAS for the particular use case. For example, for cell selection/reselection, the intended network slice may include the allowed S-NSSAIs (e.g., for idle-mode mobility) or the requested S-NSSAIs (e.g., for initial registration).

Cell selection and cell reselection may involve the UE scanning transmissions (e.g., SSB transmissions) in one or more frequency bands of one or more cells to measure the corresponding signal strength of each of the cells. The UE may then select a suitable cell on which the UE can camp on based on the cell measurements and various other cell selection criteria. Cell selection may be performed, for example, when the UE is transitioning from an RRC idle state to the RRC connected state. In addition, cell reselection may be performed when the UE is transitioning from an RRC idle state or RRC inactive state to the RRC connected state.

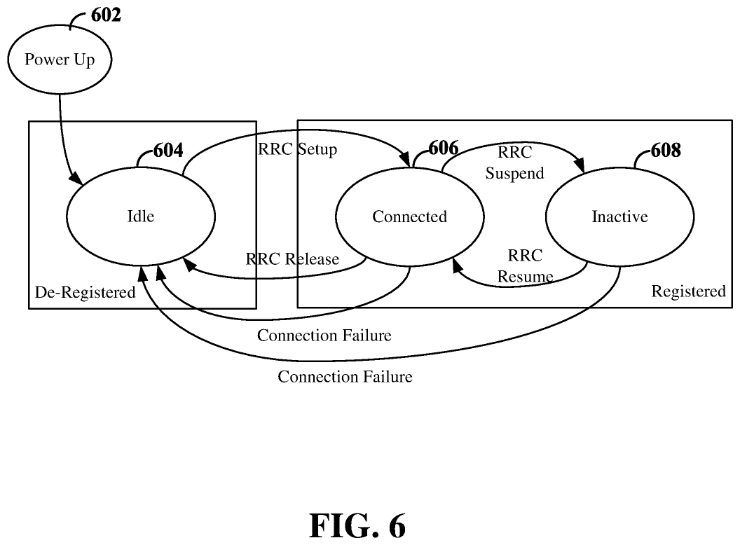

FIG. 6 illustrates an example of 5G state transitions according to some aspects. As shown in FIG. 6, when a UE first powers up 602, the UE is in a disconnected state or RRC idle state 604 in which the UE is not registered with (e.g., de-registered from) the 5G core network. The UE can move from the RRC idle state 604 to an RRC connected state 606 during initial attach (registration) or with connection establishment, as described above, to register with and connect to the 5GS. For example, the UE can perform the random access procedure shown and described above in connection with FIG. 5 to transmit the RRC setup request and transition from the RRC idle state 604 to the RRC connected state 606 (e.g., after Msg4).

While in the RRC connected state 606, if there is no activity from the UE for a period of time, the UE can transmit an RRC suspend request to move from the RRC connected state 606 to an RRC inactive state 608. Upon receiving the RRC suspend request, the UE context of the UE can be stored in the last serving base station (e.g., gNB) or an anchor gNB of the RNA within which the UE is located. In the RRC inactive state 608, the UE remains registered with 5GS.

To transition back from the RRC inactive state 608 to the RRC connected state 606, the UE may transmit an RRC resume request to the NG-RAN (e.g., gNB). The UE may transmit the RRC resume request, for example, when the low activity period is over and there is uplink data available in the uplink buffer for the UE to transmit to the NG-RAN or when there is downlink data present in the NG-RAN for the UE and the NG-RAN pages the UE. For example, the UE may monitor a paging channel on the PDDCH during paging occasions, which may be determined based on a discontinuous reception (DRX) cycle, and if a page is received for the UE from the NG-RAN, the UE may send the RRC resume request to the NG-RAN. The UE may be paged, for example, in the RNA configured for the UE. The RNA may, therefore, define an area within which the UE may move in the RRC inactive state without notifying the network. The RNA is UE-specific and configurable by the NG-RAN.

If the UE detects a new RNA during wake-up prior to the paging occasion, the UE may transmit the RRC resume request to the NG-RAN to perform an RNA update procedure, as described above. For example, prior to the paging occasion, the UE may obtain cell measurements and perform a cell reselection, if necessary, based on the cell measurements and various other cell reselection criteria. If the selected cell is in a new RNA (by comparison with the configured RNA in the UE), the UE may determine that the UE should perform an RNA update procedure. In some examples, the UE may transmit the RRC resume request to perform the RNA update and then transition back to the RRC inactive state if no paging message is received for the UE.

The UE can further transition back to the RRC idle state from the RRC inactive state or from the RRC connected state. For example, while in the RRC inactive state or RRC connected state, the UE may transition back to the RRC idle state upon experiencing a connection failure. In addition, while the UE is in the RRC connected state, the UE may transmit an RRC release request to the NG-RAN to detach from the 5GS and transition back to the RRC idle state. The NG-RAN may provide an RRC connection release message back to the UE that includes, for example, dedicated cell reselection priority information that may be utilized by the UE in cell reselection to transition back to the RRC connected state. In some examples, the dedicated cell reselection priority information may include the allowed-NSSAI for cell reselection.

Thus, for cell reselection in the RRC idle state, the UE may select an intended network slice from the allowed-NSSAI. The UE may then select a cell for cell reselection that supports the intended network slice (e.g., and further based on the cell measurements and other cell reselection criteria), and camp onto the selected cell. The supported network slices in a cell may be transmitted, for example, via a SIB. As each UE may support up to eight network slices, the total number of slices supported in a cell may be large.

However, for cell reselection when in the RRC inactive state, the intended network slice selected by the UE may be outside of the allowed-NSSAI. For example, the UE may have one or more activated PDU sessions while in the RRC inactive state. As used herein, an activated PDU session refers to a PDU session for which an access network (AN) resource (e.g., DRBs) and/or UE context is configured (here, the UE context may be suspended in the RRC inactive state). Each activated PDU session may be associated with a network slice (e.g., an S-NSSAI). Thus, the UE may select as the intended network slice, a network slice associated with one of the activated PDU sessions. If the intended network slice is outside of the allowed-NSSAI, which may include the NSSAI supported by the current tracking area (TA) of the UE, the current cell reselection procedure may not permit the UE to use the intended network slice for cell reselection.

In addition, current 3GPP 5G NR specifications do not specify the UE behavior for selecting an intended network slice in various other scenarios, including for RRC resume requests due to data transmission (e.g., uplink or downlink data) or RNA update in the RRC inactive state, for RRC reestablishment procedures in the RRC connected state, or for performing a random access procedure without any network slice information available to the UE.

Therefore, in various aspects of the disclosure, UE behavior for intended network slice selection for cell reselection in the RRC inactive state, RRC resume in the RRC inactive state, and RRC reestablishment in the RRC connected state are defined. In addition, UE behavior for selecting a RACH resource when no network slice information is available may further be defined.

In some examples, when the UE is in the RRC inactive state, the UE can select an intended network slice for cell reselection. In an example, the UE can select the intended network slice from a list of activated network slices. As used herein, activated network slices refer to network slices associated with activated PDU sessions (e.g., PDU sessions for which a UE context is established and one or more DRBs are configured). In another example, the UE can select the intended network slice from a list of allowed network slices (e.g., allowed-NSSAIs). The UE may further select the intended network slice based on a slice priority of each of the activated network slices or allowed network slices. For example, the UE may select the network slice having the highest priority among the activated network slices or allowed network slices. The slice priority may be configured by the RAN via RRC or NAS signaling, or by subscription in the UE.

In some examples, when the UE is in the RRC inactive state, the UE can select an intended network slice to perform an RRC resume procedure. The intended network slice may be utilized, for example, to select a RACH resource and/or RACH parameter(s) for performing a random access procedure to initiate the RRC resume procedure. For example, an RRC resume request may be transmitted as Msg3 in the random access procedure. The RACH resource may be, for example, a slice-specific RACH resource utilized for transmitting Msg1. The RACH parameter(s) may be, for example, slice-specific RACH parameter(s), such as powerRampingStepHighPriority, scaling FactorBI, and/or other suitable parameter.

In some examples the UE may perform the RRC resume procedure due to the presence of uplink or downlink data. For example, the UE may transmit the RRC resume request when there is uplink data available in the uplink buffer for the UE to transmit to the RAN. As another example, the UE may transmit the RRC resume request when the UE receives a paging message from the RAN indicating that downlink data is present in the RAN for the UE. In one example, the UE can select the intended network slice to perform the RRC resume procedure for a data transmission based on a slice indication (e.g., an NSSAI) of the intended network slice received at the RRC layer in the UE from an upper layer (e.g., a NAS layer) in the UE. In this example, the UE selects the RACH resource and/or RACH parameter(s) associated with the intended network slice identified by the slice identification. In another example, the UE can select the intended network slice to perform the RRC resume procedure for a data transmission from a list of activated network slices. Each activated network slice is associated with a respective activated PDU session. In addition, each activated network slice is associated with a respective slice-specific RACH resource and/or slice-specific RACH parameter(s). In examples in which there are multiple activated network slices (e.g., multiple activated PDU sessions), the UE can select the intended network slice based on a slice priority of each of the activated network slices. For example, the UE may select the network slice having the highest priority among the activated network slices. The slice priority may be configured by the RAN via RRC or NAS signaling, or by subscription in the UE.

In some examples, the UE may perform the RRC resume procedure due to an RNA update. For example, the UE may perform an RNA update when the UE has moved out of the configured RNA for the UE. In one example, the UE can select a RACH resource to perform the RRC resume procedure based on a default RACH resource. In some examples, the default RACH resource may be configured by SIB. In this example, the UE does not consider network slice information when selecting the RACH resource. In another example, the UE can select a RACH resource and/or RACH parameter(s) for performing the RRC resume procedure based a list of activated network slices. Each activated network slice is associated with a respective activated PDU session. In addition, each activated network slice is associated with a respective slice-specific RACH resource and/or slice-specific RACH parameter(s). In yet another example, the UE can select a RACH resource and/or RACH parameter(s) based on a list of allowed network slices, each associated with a respective slice-specific RACH resource and/or slice-specific RACH parameter(s). In examples in which there are multiple activated network slices (e.g., multiple activated PDU sessions) or multiple allowed network slices, the UE can select an intended network slice for the RACH resource and/or RACH parameter(s) based on a slice priority of each of the activated network slices or allowed network slices. For example, the UE may select the network slice having the highest priority among the activated or allowed network slices. The slice priority may be configured by the RAN via RRC or NAS signaling, or by subscription in the UE.

In some examples, when the UE initiates an RRC reestablishment procedure, the UE can select an intended network slice for cell selection and/or for selection of a RACH resource and/or RACH parameter(s). RRC reestablishment may be initiated by the UE, for example, when the UE has AS security (e.g., SRB2), at least one DRB configured, and detects a radio link failure, a sync failure, an integrity check failure from lower layers, or RRC connection reconfiguration failure. For example, an RRC resume request may be transmitted as Msg3 in the random access procedure. The RACH resource may be, for example, a slice-specific RACH resource utilized for transmitting Msg1. The RACH parameter(s) may be, for example, slice-specific RACH parameter(s), such as powerRampingStepHighPriority, scalingFactorBI, and/or other suitable parameter.

In one example, the UE can select the intended network slice from a list of activated network slices. Each activated network slice is associated with a respective activated PDU session. In addition, each activated network slice is associated with a respective slice-specific RACH resource and/or slice-specific RACH parameter(s). In some examples in which there are multiple activated network slices (e.g., multiple activated PDU sessions), the UE can select the intended network slice based on a slice priority of each of the activated network slices. For example, the UE may select the network slice having the highest priority among the activated network slices. The slice priority may be configured by the RAN via RRC or NAS signaling, or by subscription in the UE. In other examples in which there are multiple activated network slices, the UE can select the intended network slice associated with one of the activated PDU sessions having uplink data to be transmitted to the RAN.

In some examples, when the UE is attempting to perform a random access procedure without any network slice information or when the random access procedure is not associated with any network slice (e.g., when the UE is requesting system information or performing a TA or RA update), the UE can select a RACH resource for the random access procedure. In one example, the UE can select the RACH resource from a default RACH resource. In some examples, the default RACH resource may be configured by SIB. In this example, the UE does not consider network slice information when selecting the RACH resource. In another example, the UE can select a RACH resource for performing the random access procedure based on a respective slice priority of each of a plurality of network slices. Each of the network slices may be associated with a respective slice-specific RACH resource. For example, the UE may select the RACH resource associated with the lowest priority network slice. In this example, the slice priority may be configured by SIB or by 3GPP 5G NR specifications.

In another example, the UE can select a RACH resource for performing the random access procedure based on a set of allowed network slices. In some examples in which there are multiple allowed slices, the UE can select the RACH resource based on a slice priority of each of the allowed network slices. For example, the UE may select the network slice having the highest priority among the allowed network slices. The slice priority may be configured by the RAN via RRC or NAS signaling, or by subscription in the UE.

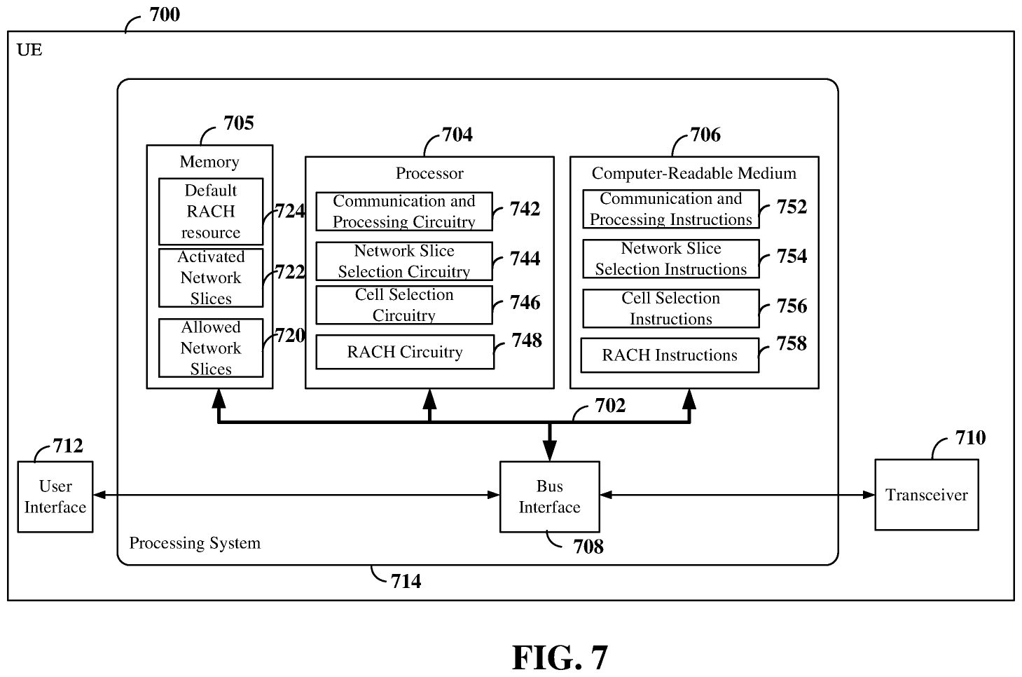

FIG. 7 is a block diagram illustrating an example of a hardware implementation for a user equipment (UE) 700 employing a processing system 714. For example, the UE 700 may correspond to any of the UEs or other scheduled entities shown and described above in reference to FIGS. 1, 2, 4 and/or 5.

The UE 700 may be implemented with a processing system 714 that includes one or more processors 704. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 700 may be configured to perform any one or more of the functions described herein. That is, the processor 704, as utilized in the UE 700, may be used to implement any one or more of the processes and procedures described below.

The processor 704 may in some instances be implemented via a baseband or modem chip and in other implementations, the processor 704 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits including one or more processors (represented generally by the processor 704), a memory 705, and computer-readable media (represented generally by the computer-readable medium 706). The bus 702 may also link various other circuits such as timing sources, peripherals, voltage regulators, and power management circuits, which are well known in the art, and therefore, will not be described any further.

A bus interface 708 provides an interface between the bus 702 and a transceiver 710. The transceiver 710 provides a communication interface or a means for communicating with various other apparatus over a transmission medium (e.g., air interface). Depending upon the nature of the apparatus, a user interface 712 (e.g., keypad, display, touch screen, speaker, microphone, control knobs, etc.) may also be provided. Of course, such a user interface 712 is optional, and may be omitted in some examples.

The processor 704 is responsible for managing the bus 702 and general processing, including the execution of software stored on the computer-readable medium 706. The software, when executed by the processor 704, causes the processing system 714 to perform the various functions described below for any particular apparatus. The computer-readable medium 706 and the memory 705 may also be used for storing data that is manipulated by the processor 704 when executing software. For example, the memory 705 may store a list of one or more allowed network slices 720 (e.g., allowed-NSSAI(s)), a list of one or more activated network slices 722, and a default RACH resource 724 used by the processor 704.

One or more processors 704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706.

The computer-readable medium 706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. In some examples, the computer-readable medium 706 may be part of the memory 705. Those skilled in the art will recognize how best to implement the described functionality presented throughout this disclosure depending on the particular application and the overall design constraints imposed on the overall system.

In some aspects of the disclosure, the processor 704 may include circuitry configured for various functions. For example, the processor 704 may include communication and processing circuitry 742, configured to communicate with a base station (e.g., gNB or eNB) via a Uu link. In some examples, the communication and processing circuitry 742 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 742 may include one or more transmit/receive chains.

In some implementations where the communication involves receiving information, the communication and processing circuitry 742 may obtain information from a component of the UE 700 (e.g., from the transceiver 710 that receives the information via radio frequency signaling or some other type of signaling suitable for the applicable communication medium), process (e.g., decode) the information, and output the processed information. For example, the communication and processing circuitry 742 may output the information to another component of the processor 704, to the memory 705, or to the bus interface 708. In some examples, the communication and processing circuitry 742 may receive one or more of signals, messages, other information, or any combination thereof. In some examples, the communication and processing circuitry 742 may receive information via one or more channels. In some examples, the communication and processing circuitry 742 may include functionality for a means for receiving. In some examples, the communication and processing circuitry 742 may include functionality for a means for processing, including a means for demodulating, a means for decoding, etc.

In some implementations where the communication involves sending (e.g., transmitting) information, the communication and processing circuitry 742 may obtain information (e.g., from another component of the processor 704, the memory 705, or the bus interface 708), process (e.g., modulate, encode, etc.) the information, and output the processed information. For example, the communication and processing circuitry 742 may output the information to the transceiver 710 (e.g., that transmits the information via radio frequency signaling or some other type of signaling suitable for the applicable communication medium). In some examples, the communication and processing circuitry 742 may send one or more of signals, messages, other information, or any combination thereof. In some examples, the communication and processing circuitry 742 may send information via one or more channels. In some examples, the communication and processing circuitry 742 may include functionality for a means for sending (e.g., a means for transmitting). In some examples, the communication and processing circuitry 742 may include functionality for a means for generating, including a means for modulating, a means for encoding, etc.

In some examples, the communication and processing circuitry 742 may be configured to transition the UE 700 between various states, such as RRC connected, RRC inactive, and RRC idle. In some examples, the communication and processing circuitry 742 may be configured to transmit an RRC suspend request to a RAN to enter an RRC inactive state from an RRC connected state. The communication and processing circuitry 742 may then be configured to transmit an RRC resume request to the RAN to perform an RRC resume procedure to transition back to the RRC connected state due to RNA update or data transmission. In addition, the communication and processing circuitry 742 may be configured to transmit an RRC reestablishment request to the RAN to perform an RRC reestablishment procedure to reestablish the RRC connected state upon detecting a failure.

In some examples, the communication and processing circuitry 742 may be configured to transmit a random access preamble (Msg1) using a selected RACH resource and a selected RACH parameter. In some examples, the selected RACH resource and/or selected RACH parameter may be slice-specific. In other examples, the selected RACH resource may be a default RACH resource 724. The default RACH resource 724 may be received by the communication and processing circuitry 742 from the RAN within a system information block (SIB). The communication and processing circuitry 742 may further be configured to transmit the RRC resume request or RRC reestablishment request in Msg3 of a random access procedure. In some examples, the RRC resume request may include an RNA update indication to update the RNA of the UE 700.

The communication and processing circuitry 742 may further be configured to transmit uplink data to a RAN upon resuming an RRC connected state from an RRC inactivate state. For example, the communication and processing circuitry 742 may be configured to identify data in an uplink buffer (e.g., memory 705) of the UE 700 and to transmit the uplink data from the uplink buffer. In addition, the communication and processing circuitry 742 may further be configured to receive a paging message from the RAN indicating that downlink data is present for the UE 700 in the RAN. The communication and processing circuitry 742 may then further be configured to receive the downlink data from the RAN upon resuming an RRC connected state from an RRC inactive state.

The communication and processing circuitry 742 may further be configured to establish one or more PDU sessions (activated PDU sessions) with a core network via the RAN. Each PDU session may have one or more configured DRBs and one or more configured SRBs. In addition, each PDU session may have a UE context associated therewith. The UE context may include, for example, a configured NSSAI for the PDU session, the requested NSSAI for the PDU session, the allowed NSSAI (allowed network slice(s) 720) for the UE, and the rejected NSSAI. As indicated above, the allowed NSSAI 720 may include a minimum common set of the requested NSSAI (or default S-NSSAI(s) if no valid S-NSSAI is requested), the subscribed NSSAI (NSSAI to which the UE is subscribed), and the NSSAI supported by the current tracking area (TA). The communication and processing circuitry 742 may further be configured to store a list of activated network slices 722, each associated with a respective one of the activated PDU sessions, within memory 705. In addition, the communication and processing circuitry 742 may be configured to store a list of allowed network slices 720 for the UE 700 (e.g., based on the activated PDU sessions and/or supported/subscribed/default S-NSSAIs) within memory 705.

The communication and processing circuitry 742 may further be configured to receive a slice priority of each of a plurality of allowed network slices 720 and/or activated network slices 722 (e.g., network slices associated with activated PDU sessions). The communication and processing circuitry 742 may receive the slice priority via NAS or RRC signaling. The communication and processing circuitry 742 may further be configured to execute communication and processing instructions (software) 752 stored in the computer-readable medium 706 to implement one or more of the functions described herein.

The processor 704 may further include network slice selection circuitry 744, configured to select an intended network slice in various use cases. In some examples, when the UE 700 is in the RRC inactive state, the network slice selection circuitry 744 can select an intended network slice for cell reselection. For example, the network slice selection circuitry 744 can select the intended network slice based on at least one of a first list of activated network slices 722 or a second list of allowed network slices 720. Each of the activated network slices 722 may be associated with a respective activated PDU session (e.g., a PDU session for which a UE context is established and one or more DRBs are configured). In examples in which there are multiple activated or allowed network slices, the network slice selection circuitry 744 may select the intended network slice based on a slice priority of each of the activated network slices 722 or allowed network slices 720. For example, the UE may select the network slice having the highest priority among the activated network slices 722 or allowed network slices 720. The slice priority may be configured by the RAN via RRC or NAS signaling, or by subscription in the UE 700.

In some examples, when the UE is in the RRC inactive state, the network slice selection circuitry 744 can select an intended network slice to perform an RRC resume procedure due to data transmission or RNA update. The intended network slice may be utilized, for example, to select a RACH resource and/or RACH parameter(s) for performing a random access procedure to initiate the RRC resume procedure. In examples in which the RRC resume procedure is performed due to the presence of uplink or downlink data to be communicated, the network slice selection circuitry 744 may be configured to select the intended network slice based on at least one of a list of activated network slices 722 or a slice indication (e.g., an NSSAI) of the intended network slice received from an upper layer (e.g., the NAS layer). Each activated network slice 722 is associated with a respective activated PDU session. In examples in which there are multiple activated network slices (e.g., multiple activated PDU sessions), the network slice selection circuitry 744 may be configured to select the intended network slice based on a slice priority of each of the activated network slices. For example, the network slice selection circuitry 744 may select the network slice having the highest priority among the activated network slices. The slice priority may be configured by the RAN via RRC or NAS signaling, or by subscription in the UE 700.

In examples in which the RRC resume procedure is performed due to an RNA update, the network slice selection circuitry 744 may be configured to select the intended network slice based on at least one of a first list of activated network slices or a second list of allowed network slices. Each activated network slice is associated with a respective activated PDU session. In examples in which there are multiple activated network slices (e.g., multiple activated PDU sessions) or multiple allowed network slices, the network slice selection circuitry 744 may be configured to select an intended network slice based on a slice priority of each of the activated network slices or allowed network slices. For example, the UE may select the network slice having the highest priority among the activated or allowed network slices. The slice priority may be configured by the RAN via RRC or NAS signaling, or by subscription in the UE 700.

In some examples, when the communication and processing circuitry 742 initiates an RRC reestablishment procedure, the network slice selection circuitry 744 may be configured to select an intended network slice for cell selection and/or for selection of a RACH resource and/or RACH parameter(s). For example, the network slice selection circuitry 744 may be configured to select the intended network slice from a list of activated network slices. Each activated network slice is associated with a respective activated PDU session. In some examples in which there are multiple activated network slices (e.g., multiple activated PDU sessions), the network slice selection circuitry 744 may be configured to select the intended network slice based on a slice priority of each of the activated network slices. For example, the UE may select the network slice having the highest priority among the activated network slices. The slice priority may be configured by the RAN via RRC or NAS signaling, or by subscription in the UE. In other examples in which there are multiple activated network slices, the network slice selection circuitry 744 may be configured to select the intended network slice associated with one of the activated PDU sessions having uplink data to be transmitted to the RAN.

In some examples, when the communication and processing circuitry 742 initiates a random access procedure without any network slice information or when the random access procedure is not associated with any network slice (e.g., when the UE is requesting system information or performing a TA or RA update), the network slice selection circuitry 744 may be configured to select an intended network slice for the random access procedure based on a respective slice priority of each of a plurality of network slices or a set of allowed network slices 720 of the plurality of network slices. In examples in which the intended network slice is selected based on the priority of the plurality of network slices, the network slice selection circuitry 744 may be configured to select the lowest priority network slice. In this example, the slice priority may be configured by SIB or by 3GPP 5G NR specifications. In examples in which the intended network slice is selected based on the list of allowed network slices 720, the network slice selection circuitry 744 may be configured to select the intended network slice based on a slice priority of each of the allowed network slices 720. For example, the network slice selection circuitry 744 may be configured to select the network slice having the highest priority among the allowed network slices 720. In this example, the slice priority may be configured by the RAN via RRC or NAS signaling, or by subscription in the UE. The network slice selection circuitry 744 may further be configured to execute network slice selection instructions (software) 754 stored in the computer-readable medium 706 to implement one or more of the functions described herein.

The processor 704 may further include cell selection circuitry 746, configured to perform a cell selection or cell reselection to select a cell and camp onto the selected cell. In some examples, the cell selection circuitry 746 may be configured to perform a cell reselection when the UE 700 is in an RRC inactive state. In this example, the cell selection circuitry 746 may be configured to select a cell on which to camp based on the intended network slice selected by the network slice selection circuitry 744. For example, the cell selection circuitry 746 may select a cell that supports the intended network slice on which to camp. In some examples, the cell selection circuitry 746 may be configured to perform a cell selection to perform an RRC reestablishment procedure. In this example, the cell selection circuitry 746 may be configured to select a cell on which to camp to perform the RRC reestablishment procedure based on the intended network slice selected by the network slice selection circuitry 744. For example, the cell selection circuitry 746 may select a cell that supports the intended network slice on which to camp. The cell selection circuitry 746 may further be configured to execute cell selection instructions (software) 756 stored in the computer-readable medium 706 to implement one or more of the functions described herein.

The processor 704 may further include RACH circuitry 748, configured to perform a random access procedure. In some examples, the RACH circuitry 748 may be configured to initiate a random access procedure to perform an RRC resume procedure due to data transmission when the UE is in an RRC inactive state. In this example, the RACH circuitry 748 may further be configured to perform the random access procedure using a RACH resource and/or RACH parameters(s) selected based on the intended network slice selected by the network slice selection circuitry 744. For example, the RACH resource may be a slice-specific RACH resource utilized for transmitting Msg1. The RACH parameter(s) may be, for example, slice-specific RACH parameter(s), such as powerRampingStepHighPriority, scalingFactorBI, and/or other suitable parameter. In this example, the selected RACH resource and/or selected RACH parameter(s) may be associated with the intended network slice selected for the RRC resume procedure. The RACH circuitry 748 may further be configured to transmit the RRC resume request within Msg3 of the random access procedure.

In some examples, the RACH circuitry 748 may be configured to initiate a random access procedure to perform an RRC resume procedure due to an RNA update when the UE is in an RRC inactive state. In this example, the RACH circuitry 748 may further be configured to perform the random access procedure using a RACH resource and/or RACH parameters(s) selected based on either the default RACH resource 724 or the intended network slice selected by the network slice selection circuitry 744. As indicated above, the default RACH resource 724 for Msg1 may be configured by SIB. In this example, the RACH circuitry 748 does not consider network slice information when selecting the RACH resource. In examples in which the intended network slice is utilized in selection of the RACH resource and/or RACH parameter(s) for Msg1, the selected RACH resource may be a slice-specific RACH resource associated with the intended network slice and/or the selected RACH parameter(s) may be slice-specific RACH parameters associated with the intended network slice. The RACH circuitry 748 may further be configured to transmit the RRC resume request within Msg3 of the random access procedure.

In some examples, the RACH circuitry 748 may be configured to initiate a random access procedure to perform an RRC reestablishment procedure. For example, the RACH circuitry 748 may be configured to perform the random access procedure using a RACH resource and/or RACH parameters(s) selected based on the intended network slice selected by the network slice selection circuitry 744, as described above. The RACH circuitry 748 may further be configured to transmit the RRC reestablishment request within Msg3 of the random access procedure.

In some examples, the RACH circuitry 748 may be configured to initiate a random access procedure without any network slice information. For example, the RACH circuitry 748 may be configured to perform the random access procedure using a RACH resource and/or RACH parameters(s) selected based on either the default RACH resource 724 or the intended network slice selected by the network slice selection circuitry 744, as described above. The RACH circuitry 748 may further be configured to execute RACH instructions (software) 758 stored in the computer-readable medium 706 to implement one or more of the functions described herein.

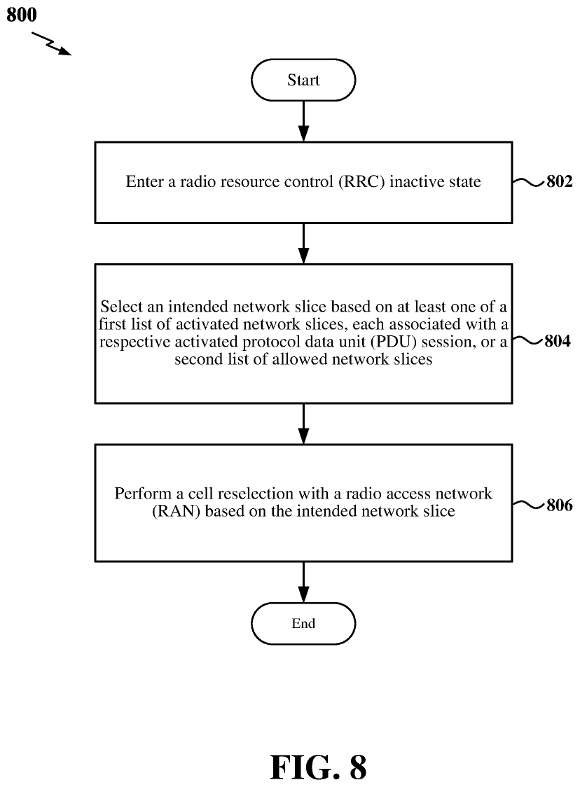

FIG. 8 is a flow chart 800 of a method for wireless communication at a UE in accordance with some aspects of the present disclosure. As described below, some or all illustrated features may be omitted in a particular implementation within the scope of the present disclosure, and some illustrated features may not be required for implementation of all examples. In some examples, the process 800 may be carried out by the UE 700 illustrated in FIG. 7. In some examples, the process 800 may be carried out by any suitable apparatus or means for carrying out the functions or algorithm described below.

At block 802, the UE may enter a radio resource control (RRC) inactive state. For example, the UE may transmit an RRC suspend request to a radio access network (RAN) to transition from the RRC connected state to the RRC inactive state during periods of inactivity (e.g., which may be based on a DRX cycle). For example, the communication and processing circuitry 742 shown and described above in connected with FIG. 7 may provide a means to enter the RRC inactive state.

At block 804, the UE may select an intended network slice based on at least one of a first list of activated network slices, each associated with a respective activated protocol data unit (PDU) session, or a second list of allowed network slices. In some examples, the UE may select the intended network slice from a plurality of network slices. The plurality of network slices may include each of the activated network slices associated with the first list or each of the allowed network slices associated with the second list. In this example, each of the plurality of network slices may include a respective slice priority. The UE may then select the intended network slice based on the respective slice priority of each of the plurality of network slices. For example, the intended network slice may have a highest slice priority. In some examples, the UE may receive the respective slice priority of each of the plurality of network slices via an RRC message or a non-access stratum (NAS) message. In other examples, the respective slice priority may be configured via subscription in the UE. For example, the network slice selection circuitry 744 shown and described above in connection with FIG. 7 may provide a means to select the intended network slice.

At block 806, the UE may perform a cell reselection with the RAN based on the intended network slice. For example, the UE may select a cell supporting the intended network slice for the cell reselection. For example, the cell selection circuitry 746 shown and described above in connection with FIG. 7 may provide a means to perform the cell reselection based on the intended network slice.

In one configuration, the apparatus 700 for wireless communication includes means for entering a radio resource control (RRC) inactive state, means for selecting an intended network slice based on at least one of a first list of activated network slices, each associated with a respective activated protocol data unit (PDU) session, or a second list of allowed network slices, and means for performing a cell reselection with a radio access network (RAN) based on the intended network slice. In one aspect, the aforementioned means may be the processor 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, 4, and/or 5, and utilizing, for example, the processes and/or algorithms described herein in relation to FIG. 8.

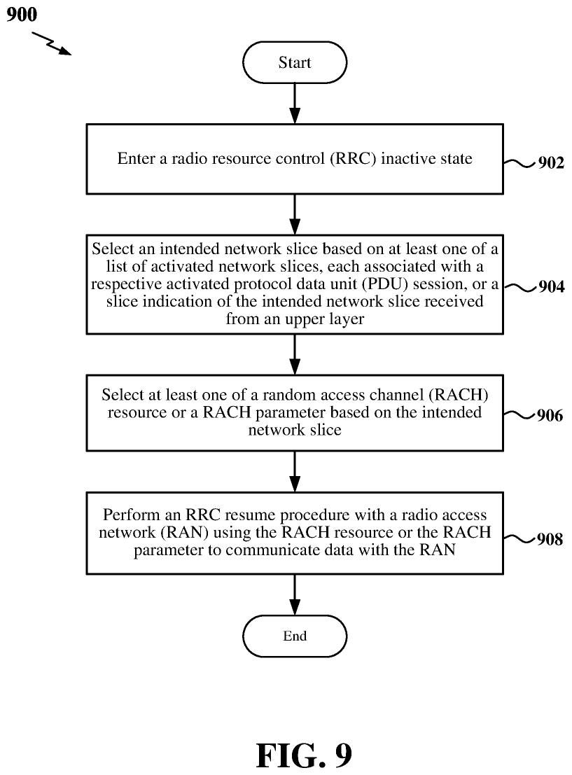

FIG. 9 is a flow chart 900 of another method for wireless communication at a UE in accordance with some aspects of the present disclosure. As described below, some or all illustrated features may be omitted in a particular implementation within the scope of the present disclosure, and some illustrated features may not be required for implementation of all examples. In some examples, the process 900 may be carried out by the UE 700 illustrated in FIG. 7. In some examples, the process 900 may be carried out by any suitable apparatus or means for carrying out the functions or algorithm described below.

At block 902, the UE may enter a radio resource control (RRC) inactive state. For example, the UE may transmit an RRC suspend request to a radio access network (RAN) to transition from the RRC connected state to the RRC inactive state during periods of inactivity (e.g., which may be based on a DRX cycle). For example, the communication and processing circuitry 742 shown and described above in connected with FIG. 7 may provide a means to enter the RRC inactive state.

At block 904, the UE may select an intended network slice based on at least one of a list of activated network slices, each associated with a respective activated protocol data unit (PDU) session, or a slice indication of the intended network slice received from an upper layer. In some examples, the UE may receive the slice indication from a NAS layer at an RRC layer of the UE. In some examples, the UE may select the intended network slice from a plurality of network slices. The plurality of network slices may include each of the activated network slices associated with the list. In this example, each of the plurality of network slices may further include a respective slice priority. The UE may then select the intended network slice based on the respective slice priority of each of the plurality of network slices. For example, the intended network slice may have a highest slice priority. In some examples, the UE may receive the respective slice priority of each of the plurality of network slices via an RRC message or a non-access stratum (NAS) message. In other examples, the respective slice priority may be configured via subscription in the UE. For example, the network slice selection circuitry 744 shown and described above in connection with FIG. 7 may provide a means to select the intended network slice.

At block 906, the UE may select at least one of a random access channel (RACH) resource or a RACH parameter based on the intended network slice. For example, the RACH circuitry 748 shown and described above in connection with FIG. 7 may select the RACH resource and/or RACH parameter based on the intended network slice.

At block 910, the UE may perform an RRC resume procedure with the RAN using the RACH resource or the RACH parameter to communicate data with the RAN. In some examples, the UE may perform a random access procedure using the RACH resource or the RACH parameter, and transmit an RRC resume request during the random access procedure. In some examples, the UE may initiate the RRC resume procedure upon receiving a paging message from the RAN indicating the data is present at the RAN for transmission to the UE or identifying the data in an uplink buffer of the UE. For example, the RACH circuitry 748, together with the communication and processing circuitry 742 and transceiver 710, shown and described above in connection with FIG. 7 may provide a means to perform the RRC resume procedure with the RAN using the RACH resource or the RACH parameter.

In one configuration, the apparatus 700 for wireless communication includes means for entering a radio resource control (RRC) inactive state, means for selecting at least one of a random access channel (RACH) resource or a RACH parameter based on at least one of a first list of activated network slices, each associated with a respective activated protocol data unit (PDU) session, a second list of allowed network slices, or a default RACH resource, and means performing an RRC resume procedure with a radio access network (RAN) using the RACH resource or the RACH parameter to perform the RNA update. In one aspect, the aforementioned means may be the processor 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, 4, and/or 5, and utilizing, for example, the processes and/or algorithms described herein in relation to FIG. 9.

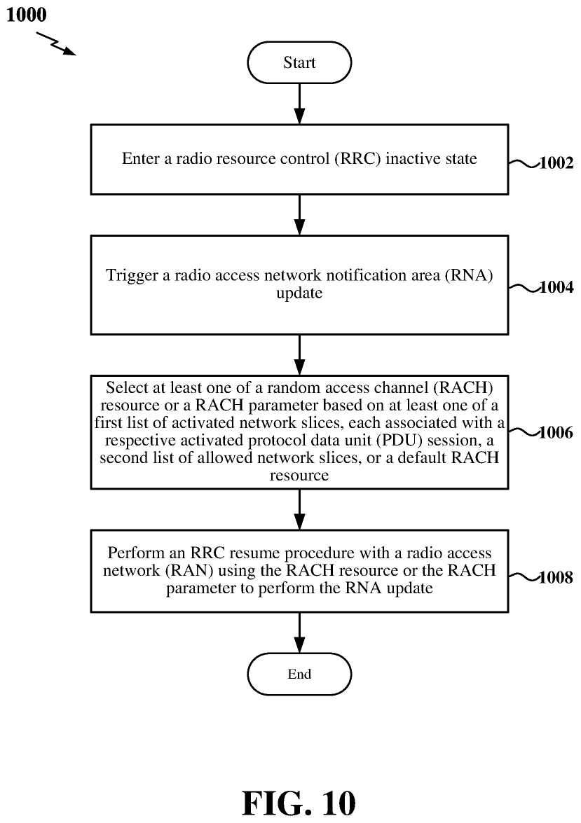

FIG. 10 is a flow chart 1000 of another method for wireless communication at a UE in accordance with some aspects of the present disclosure. As described below, some or all illustrated features may be omitted in a particular implementation within the scope of the present disclosure, and some illustrated features may not be required for implementation of all examples. In some examples, the process 1000 may be carried out by the UE 700 illustrated in FIG. 7. In some examples, the process 1000 may be carried out by any suitable apparatus or means for carrying out the functions or algorithm described below.

At block 1002, the UE may enter a radio resource control (RRC) inactive state. For example, the UE may transmit an RRC suspend request to a radio access network (RAN) to transition from the RRC connected state to the RRC inactive state during periods of inactivity (e.g., which may be based on a DRX cycle). For example, the communication and processing circuitry 742 shown and described above in connected with FIG. 7 may provide a means to enter the RRC inactive state.

At block 1004, the UE may trigger a radio access network notification area (RNA) update. For example, the UE may perform an RNA update when the UE has moved out of the configured RNA for the UE. For example, the communication and processing circuitry 742 shown and described above in connection with FIG. 7 may provide a means to trigger the RNA update.

At block 1006, the UE may select at least one of a random access channel (RACH) resource or a RACH parameter based on at least one of a first list of activated network slices, each associated with a respective activated protocol data unit (PDU) session, a second list of allowed network slices, or a default RACH resource. In some examples, the UE may select an intended network slice from a plurality of network slices. The plurality of network slices may include each of the activated network slices associated with the first list or each of the allowed network slices associated with the second list. The UE may then select at least one of the RACH resource or the RACH parameter based on the intended network slice. In this example, each of the plurality of network slices may further include a respective slice priority. The UE may then select the intended network slice based on the respective slice priority of each of the plurality of network slices. For example, the intended network slice may have a highest slice priority. In some examples, the UE may receive the respective slice priority of each of the plurality of network slices via an RRC message or a non-access stratum (NAS) message. In other examples, the respective slice priority may be configured via subscription in the UE. For example, the RACH circuitry 748, together with the network slice selection circuitry 744, shown and described above in connection with FIG. 7 may provide a means to select the RACH resource and/or RACH parameter.

At block 1008, the UE may perform an RRC resume procedure with the RAN using the RACH resource or the RACH parameter to perform the RNA update. In some examples, the UE may perform a RACH procedure using the RACH resource or the RACH parameter, and transmit an RRC resume request during the RACH procedure. For example, the RACH circuitry 748, together with the communication and processing circuitry 742 and transceiver 710, shown and described above in connection with FIG. 7 may provide a means to perform the RRC resume procedure with the RAN using the RACH resource or the RACH parameter.

In one configuration, the apparatus 700 for wireless communication includes means for entering a radio resource control (RRC) inactive state, means for triggering a radio access network notification area (RNA) update, means for selecting an intended network slice based on at least one of a first list of activated network slices, each associated with a respective activated protocol data unit (PDU) session, a second list of allowed network slices, or a default network slice, means for selecting at least one of a random access channel (RACH) resource or a RACH parameter based on the intended network slice, and means performing an RRC resume procedure with a radio access network (RAN) using the RACH resource or the RACH parameter to perform the RNA update. In one aspect, the aforementioned means may be the processor 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, 4, and/or 5, and utilizing, for example, the processes and/or algorithms described herein in relation to FIG. 10.

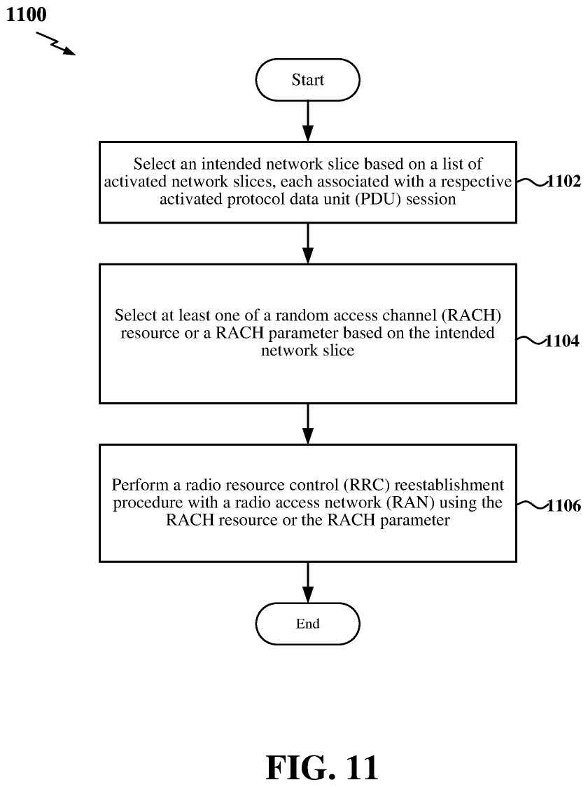

FIG. 11 is a flow chart 1100 of another method for wireless communication at a UE in accordance with some aspects of the present disclosure. As described below, some or all illustrated features may be omitted in a particular implementation within the scope of the present disclosure, and some illustrated features may not be required for implementation of all examples. In some examples, the process 1100 may be carried out by the UE 700 illustrated in FIG. 7. In some examples, the process 1100 may be carried out by any suitable apparatus or means for carrying out the functions or algorithm described below.

At block 1102, the UE may select an intended network slice based on a list of activated network slices, each associated with a respective activated protocol data unit (PDU) session. In some examples, the UE may select the intended network slice from a plurality of network slices. The plurality of network slices may include each of the activated network slices associated with the list. In this example, each of the plurality of network slices may include a respective slice priority. The UE may then select the intended network slice based on the respective slice priority of each of the plurality of network slices. For example, the UE may receive respective slice priority of each of the plurality of network slices via a radio resource control (RRC) message of a non-access stratum (NAS) message. In some examples, the UE may select the intended network slice associated with one of the activated PDU sessions having uplink data to be transmitted to the RAN. In some examples, the UE may further select a cell supporting the intended network slice for cell reselection to which the RRC reestablishment procedure is performed. For example, the network slice selection circuitry 744, together with the cell selection circuitry 746, shown and described above in connection with FIG. 7 may provide a means to select the intended network slice.

At block 1104, the UE may select at least one of a random access channel (RACH) resource or a RACH parameter based on the intended network slice. For example, the RACH circuitry 748 shown and described above in connection with FIG. 7 may select the RACH resource and/or RACH parameter based on the intended network slice.

At block 1106, the UE may perform a radio resource control (RRC) reestablishment procedure with the RAN using the RACH resource or the RACH parameter. In some examples, the UE may perform a RACH procedure using the RACH resource or the RACH parameter, and transmit an RRC reestablishment request during the RACH procedure. For example, the RACH circuitry 748, together with the communication and processing circuitry 742 and transceiver 710, shown and described above in connection with FIG. 7 may provide a means to perform the RRC reestablishment procedure with the RAN using the RACH resource or the RACH parameter.

In one configuration, the apparatus 700 for wireless communication includes means for selecting an intended network slice based on a list of activated network slices, each associated with a respective activated protocol data unit (PDU) session, means for selecting at least one of a random access channel (RACH) resource or a RACH parameter based on the intended network slice, and means performing a radio resource control (RRC) reestablishment procedure with a radio access network (RAN) using the RACH resource or the RACH parameter. In one aspect, the aforementioned means may be the processor 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, 4, and/or 5, and utilizing, for example, the processes and/or algorithms described herein in relation to FIG. 11.

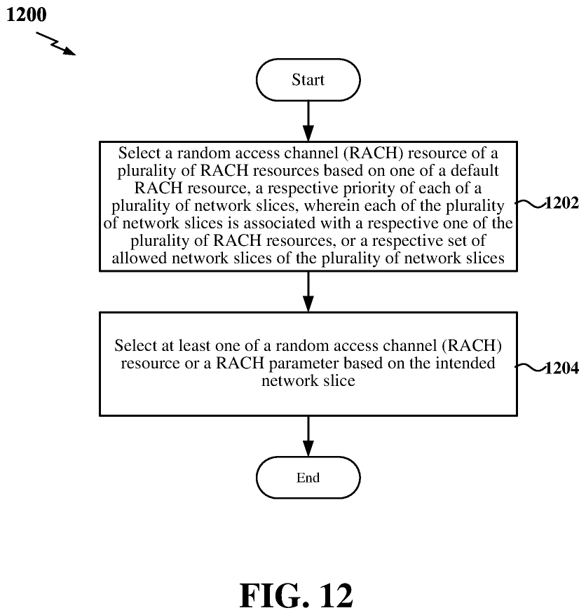

FIG. 12 is a flow chart 1200 of another method for wireless communication at a UE in accordance with some aspects of the present disclosure. As described below, some or all illustrated features may be omitted in a particular implementation within the scope of the present disclosure, and some illustrated features may not be required for implementation of all examples. In some examples, the process 1200 may be carried out by the UE 700 illustrated in FIG. 7. In some examples, the process 1200 may be carried out by any suitable apparatus or means for carrying out the functions or algorithm described below.

At block 1202, the UE may select a random access channel (RACH) resource of a plurality of RACH resources based on one of a default RACH resource configured for when no network slice is indicated, a respective priority of each of a plurality of network slices, wherein each of the plurality of network slices is associated with a respective one of the plurality of RACH resources, or a respective set of allowed network slices of the plurality of network slices. In some examples, the UE may select the selected RACH resource associated with a lowest priority network slice having a lowest priority among the plurality of network slices. In some examples, the UE may receive a system information block (SIB) including the respective priority of each of the plurality of network slices from the RAN. In some examples, the UE may select the selected RACH resource associated with an allowed network slice of the set of allowed network slices. In some examples, each of the set of allowed network slices includes a respective slice priority. In this example, the UE may select the selected RACH resource based on the respective slice priority of each of the set of allowed network slice. For example, the RACH circuitry 748, together with the network slice selection circuitry 744, shown and described above in connection with FIG. 7 may provide a means to select the RACH resource.

At block 1204, the UE may perform a RACH procedure with the RAN using the selected RACH resource. For example, the RACH circuitry 748, together with the communication and processing circuitry 742 and transceiver 710, shown and described above in connection with FIG. 7 may provide a means to perform the RACH procedure using the selected RACH resource.

In one configuration, the apparatus 700 for wireless communication includes means for selecting a random access channel (RACH) resource of a plurality of RACH resources based on one of a default RACH resource configured for when no network slice is indicated, a respective slice priority of each of a plurality of network slices, wherein each of the plurality of network slices is associated with a respective one of the plurality of RACH resources, or a respective set of allowed network slices of the plurality of network slices, and means for performing a random access procedure with a radio access network (RAN) using the selected RACH resource. In one aspect, the aforementioned means may be the processor 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, 4, and/or 5, and utilizing, for example, the processes and/or algorithms described herein in relation to FIG. 12.

The processes shown in FIGS. 8-12 may include additional aspects, such as any single aspect or any combination of aspects described below and/or in connection with one or more other processes described elsewhere herein.

Aspect 1: A method for wireless communication at a user equipment, the method comprising: entering a radio resource control (RRC) inactive state; selecting an intended network slice based on at least one of a first list of activated network slices, each associated with a respective activated protocol data unit (PDU) session, or a second list of allowed network slices; and performing a cell reselection with a radio access network (RAN) based on the intended network slice.

Aspect 2: The method of aspect 1, wherein the selecting the intended network slice further comprises: selecting the intended network slice from a plurality of network slices, wherein the plurality of network slices comprises each of the activated network slices associated with the first list or each of the allowed network slices associated with the second list.

Aspect 3: The method of aspect 2, wherein each of the plurality of network slices comprises a respective slice priority, and the selecting the intended network slice further comprises: selecting the intended network slice based on the respective slice priority of each of the plurality of network slices.

Aspect 4: The method of aspect 3, further comprising: receiving the respective slice priority of each of the plurality of network slices via an RRC message or a non-access stratum (NAS) message.

Aspect 5: The method of any of aspects 1 through 4, wherein the performing the cell reselection based on the intended network slice comprises: selecting a cell supporting the intended network slice for the cell reselection.

Aspect 6: A method for wireless communication at a user equipment, the method comprising: entering a radio resource control (RRC) inactive state; selecting an intended network slice based on at least one of a list of activated network slices, each associated with a respective activated protocol data unit (PDU) session, or a slice indication of the intended network slice received from an upper layer; selecting at least one of a random access channel (RACH) resource or a RACH parameter based on the intended network slice; and performing an RRC resume procedure with a radio access network (RAN) using the RACH resource or the RACH parameter to communicate data with the RAN.

Aspect 7: The method of aspect 6, wherein the selecting the intended network slice further comprises: selecting the intended network slice from a plurality of network slices, wherein the plurality of network slices comprises each of the activated network slices associated with the list.

Aspect 8: The method of aspect 7, wherein each of the plurality of network slices comprises a respective slice priority, and the selecting the intended network slice further comprises: selecting the intended network slice based on the respective slice priority of each of the plurality of network slices.

Aspect 9: The method of aspect 8, further comprising: receiving the respective slice priority of each of the plurality of network slices via a radio resource control (RRC) message or a non-access stratum (NAS) message.

Aspect 10: The method of any of aspects 6 through 9, wherein the performing the RRC resume procedure comprises: performing a random access procedure using the RACH resource or the RACH parameter; and transmitting an RRC resume request during the random access procedure.

Aspect 11: The method of aspect 6 or 10, wherein the selecting the intended network slice further comprises: receiving the slice indication from a non-access stratum (NAS) layer at an RRC layer.

Aspect 12: The method of any of aspects 6 through 11, further comprising: receiving a paging message from the RAN indicating the data is present at the RAN for transmission to the UE; or identifying the data in an uplink buffer of the UE.

Aspect 13: A method for wireless communication at a user equipment, the method comprising: entering a radio resource control (RRC) inactive state; triggering a radio access network notification area (RNA) update; selecting at least one of a random access channel (RACH) resource or a RACH parameter based on at least one of a first list of activated network slices, each associated with a respective activated protocol data unit (PDU) session, a second list of allowed network slices, or a default RACH resource; and performing an RRC resume procedure with a radio access network (RAN) using the RACH resource or the RACH parameter to perform the RNA update.

Aspect 14: The method of aspect 13, further comprising: selecting an intended network slice from a plurality of network slices, wherein the plurality of network slices comprises each of the activated network slices associated with the first list or each of the allowed network slices associated with the second list, wherein the selecting at least one of the RACH resource or the RACH parameter further comprises: selecting at least one of the RACH resource or the RACH parameter based on the intended network slice.

Aspect 15: The method of aspect 14, wherein each of the plurality of network slices comprises a respective slice priority, and the selecting the intended network slice further comprises: selecting the intended network slice based on the respective slice priority of each of the plurality of network slices.

Aspect 16: The method of aspect 15, further comprising: receiving the respective slice priority of each of the plurality of network slices via a radio resource control (RRC) message or a non-access stratum (NAS) message.

Aspect 17: The method of any of aspects 13 through 16, wherein the performing the RRC resume procedure comprises: performing a random access procedure using the RACH resource or the RACH parameter; and transmitting an RRC resume request during the random access procedure.

Aspect 18: A method for wireless communication at a user equipment, the method comprising: selecting an intended network slice based on a list of activated network slices, each associated with a respective activated protocol data unit (PDU) session; selecting at least one of a random access channel (RACH) resource or a RACH parameter based on the intended network slice; and performing a radio resource control (RRC) reestablishment procedure with a radio access network (RAN) using the RACH resource or the RACH parameter.

Aspect 19: The method of aspect 18, wherein the selecting the intended network slice further comprises: selecting the intended network slice from a plurality of network slices, wherein the plurality of network slices comprises each of the activated network slices associated with the list.

Aspect 20: The method of aspect 19, wherein each of the plurality of network slices comprises a respective slice priority, and the selecting the intended network slice further comprises: selecting the intended network slice based on the respective slice priority of each of the plurality of network slices.

Aspect 21: The method of aspect 20, further comprising: receiving the respective slice priority of each of the plurality of network slices via a radio resource control (RRC) message or a non-access stratum (NAS) message.

Aspect 22: The method of any of aspects 18 through 21, wherein the selecting the intended network slice further comprises: selecting the intended network slice associated with one of the activated PDU sessions having uplink data to be transmitted to the RAN.

Aspect 23: The method of any of aspects 18 through 22, wherein the performing the RRC reestablishment procedure comprises: performing a random access procedure using the RACH resource or the RACH parameter; and transmitting an RRC reestablishment request during the random access procedure.

Aspect 24: The method of any of aspects 18 through 23, wherein the selecting the intended network slice further comprises: selecting a cell supporting the intended network slice for cell reselection to which the RRC reestablishment procedure is performed.

Aspect 25: A method for wireless communication at a user equipment, the method comprising: selecting a random access channel (RACH) resource of a plurality of RACH resources based on one of a default RACH resource configured for when no network slice is indicated, a respective slice priority of each of a plurality of network slices, wherein each of the plurality of network slices is associated with a respective one of the plurality of RACH resources, or a respective set of allowed network slices of the plurality of network slices; and performing a random access procedure with a radio access network (RAN) using the selected RACH resource.

Aspect 26: The method of aspect 25, wherein the selecting the selected RACH resource further comprises: selecting the selected RACH resource associated with a lowest priority network slice having a lowest priority among the plurality of network slices.

Aspect 27: The method of aspect 26, further comprising: receiving a system information block (SIB) comprising the respective slice priority of each of the plurality of network slices from the RAN.

Aspect 28: The method of aspect 25, wherein the selecting the selected RACH resource further comprises: selecting the selected RACH resource associated with an allowed network slice of the set of allowed network slices.

Aspect 29: The method of aspect 28, wherein each of the set of allowed network slices comprises a respective slice priority, and the selecting the selected RACH resource further comprises: selecting the selected RACH resource based on the respective slice priority of each of the set of allowed network slices.

Aspect 30: A user equipment (UE) in a wireless communication network comprising a transceiver, a memory, and a processor coupled to the transceiver and the memory, the processor and the memory configured to perform a method of any one of aspects 1 through 5, aspects 6 through 12, aspects 13 through 17, aspects 18 through 24, or aspects 25 through 29.

Aspect 31: An apparatus for wireless communication comprising at least one means for performing a method of any one of aspects 1 through 5, aspects 6 through 12, aspects 13 through 17, aspects 18 through 24, or aspects 25 through 29.

Aspect 32: A non-transitory computer-readable medium having stored therein instructions executable by one or more processors of a user equipment to perform a method of any one of aspects 1 through 5, aspects 6 through 12, aspects 13 through 17, aspects 18 through 24, or aspects 25 through 29.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “obtaining” may include one or more actions including, but not limited to, receiving, generating, determining, or any combination thereof.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 5, and/or 7 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) in a wireless communication network, comprising:
a transceiver;
a memory; and
a processor coupled to the transceiver and the memory,
the processor and the memory being configured to:
enter a radio resource control (RRC) inactive state;
select an intended network slice based on at least one of a list of activated network slices, each associated with a respective activated protocol data unit (PDU) session, or a slice indication of the intended network slice received from an upper layer;
select at least one of a random access channel (RACH) resource or a RACH parameter based on the intended network slice; and
perform an RRC resume procedure with a radio access network (RAN) using the RACH resource or the RACH parameter to communicate data with the RAN via the transceiver.

2. The UE of claim 1, wherein the processor and the memory are further configured to:
select the intended network slice from a plurality of network slices, wherein the plurality of network slices comprises each of the activated network slices associated with the list.

3. The UE of claim 2, wherein each of the plurality of network slices comprises a respective slice priority, and the processor and the memory are further configured to:
select the intended network slice based on the respective slice priority of each of the plurality of network slices.

4. The UE of claim 3, wherein the processor and the memory are further configured to:
receive the respective slice priority of each of the plurality of network slices via a radio resource control (RRC) message or a non-access stratum (NAS) message.

5. The UE of claim 1, wherein the processor and the memory are further configured to:
perform a random access procedure using the RACH resource or the RACH parameter; and
transmit an RRC resume request during the random access procedure.

6. The UE of claim 1, wherein the processor and the memory are further configured to:
receive the slice indication from a non-access stratum (NAS) layer at an RRC layer.

7. The UE of claim 1, wherein the processor and the memory are further configured to:
receive a paging message from the RAN indicating the data is present at the RAN for transmission to the UE.

8. The UE of claim 1, wherein the processor and the memory are further configured to:
identify the data in an uplink buffer of the UE.

9. A method for wireless communication at a user equipment (UE), the method comprising:
entering a radio resource control (RRC) inactive state;
selecting an intended network slice based on at least one of a list of activated network slices, each associated with a respective activated protocol data unit (PDU) session, or a slice indication of the intended network slice received from an upper layer;
selecting at least one of a random access channel (RACH) resource or a RACH parameter based on the intended network slice; and
performing an RRC resume procedure with a radio access network (RAN) using the RACH resource or the RACH parameter to communicate data with the RAN.

10. The method of claim 9, wherein the selecting the intended network slice further comprises:
selecting the intended network slice from a plurality of network slices, wherein the plurality of network slices comprises each of the activated network slices associated with the list.

11. The method of claim 10, wherein each of the plurality of network slices comprises a respective slice priority, and the selecting the intended network slice further comprises:
selecting the intended network slice based on the respective slice priority of each of the plurality of network slices.

12. The method of claim 11, further comprising:
receiving the respective slice priority of each of the plurality of network slices via a radio resource control (RRC) message or a non-access stratum (NAS) message.

13. The method of claim 9, wherein the performing the RRC resume procedure comprises:
performing a random access procedure using the RACH resource or the RACH parameter; and
transmitting an RRC resume request during the random access procedure.

14. The method of claim 9, wherein the selecting the intended network slice further comprises:
receiving the slice indication from a non-access stratum (NAS) layer at an RRC layer.

15. The method of claim 9, further comprising:
receiving a paging message from the RAN indicating the data is present at the RAN for transmission to the UE.

16. The method of claim 9, further comprising:
identifying the data in an uplink buffer of the UE.

17. An apparatus for wireless communication, comprising:
means for entering a radio resource control (RRC) inactive state;
means for selecting an intended network slice based on at least one of a list of activated network slices, each associated with a respective activated protocol data unit (PDU) session, or a slice indication of the intended network slice received from an upper layer;
means for selecting at least one of a random access channel (RACH) resource or a RACH parameter based on the intended network slice; and
means for performing an RRC resume procedure with a radio access network (RAN) using the RACH resource or the RACH parameter to communicate data with the RAN.

18. The apparatus of claim 17, wherein the means for selecting the intended network slice further comprises:
means for selecting the intended network slice from a plurality of network slices, wherein the plurality of network slices comprises each of the activated network slices associated with the list.

19. The apparatus of claim 18, wherein each of the plurality of network slices comprises a respective slice priority, and the means for selecting the intended network slice further comprises:
means for selecting the intended network slice based on the respective slice priority of each of the plurality of network slices.

20. The apparatus of claim 19, further comprising:
means for receiving the respective slice priority of each of the plurality of network slices via a radio resource control (RRC) message or a non-access stratum (NAS) message.

21. The apparatus of claim 17, wherein the means for performing the RRC resume procedure comprises:
means for performing a random access procedure using the RACH resource or the RACH parameter; and
means for transmitting an RRC resume request during the random access procedure.

22. The apparatus of claim 17, wherein the means for selecting the intended network slice further comprises:
means for receiving the slice indication from a non-access stratum (NAS) layer at an RRC layer.

23. The apparatus of claim 17, further comprising:
means for receiving a paging message from the RAN indicating the data is present at the RAN for transmission to the apparatus; or
means for identifying the data in an uplink buffer of the apparatus.

24. A non-transitory computer-readable medium having stored therein instructions executable by one or more processors of a user equipment (UE) to:
enter a radio resource control (RRC) inactive state;
select an intended network slice based on at least one of a list of activated network slices, each associated with a respective activated protocol data unit (PDU) session, or a slice indication of the intended network slice received from an upper layer;
select at least one of a random access channel (RACH) resource or a RACH parameter based on the intended network slice; and
perform an RRC resume procedure with a radio access network (RAN) using the RACH resource or the RACH parameter to communicate data with the RAN.

25. The non-transitory computer-readable medium of claim 24, further comprising instructions executable by the one or more processors of the user equipment to:
select the intended network slice from a plurality of network slices, wherein the plurality of network slices comprises each of the activated network slices associated with the list.

26. The non-transitory computer-readable medium of claim 25, wherein each of the plurality of network slices comprises a respective slice priority, and further comprising instructions executable by the one or more processors of the user equipment to:
select the intended network slice based on the respective slice priority of each of the plurality of network slices.

27. The non-transitory computer-readable medium of claim 26, further comprising instructions executable by the one or more processors of the user equipment to:
receive the respective slice priority of each of the plurality of network slices via a radio resource control (RRC) message or a non-access stratum (NAS) message.

28. The non-transitory computer-readable medium of claim 24, further comprising instructions executable by the one or more processors of the user equipment to:
perform a random access procedure using the RACH resource or the RACH parameter; and
transmit an RRC resume request during the random access procedure.

29. The non-transitory computer-readable medium of claim 24, further comprising instructions executable by the one or more processors of the user equipment to:
receive the slice indication from a non-access stratum (NAS) layer at an RRC layer.

30. The non-transitory computer-readable medium of claim 24, further comprising instructions executable by the one or more processors of the user equipment to:
receive a paging message from the RAN indicating the data is present at the RAN for transmission to the UE; or
identify the data in an uplink buffer of the UE.
